(19) United States
(12) Patent Application Publication
(10) Pub. No.: US 2014/0330456 A1
(43) Pub. Date: Nov. 6, 2014

(54) LANDING SITE DESIGNATION IN AN AUTONOMOUS DELIVERY NETWORK

(71) Applicants: Manuel R. Lopez Morales, East Palo Alto, CA (US); Aamir Patel, Saratoga, CA (US); Raj V. Abhyanker, Cupertino, CA (US)

(72) Inventors: Manuel R. Lopez Morales, East Palo Alto, CA (US); Aamir Patel, Saratoga, CA (US); Raj V. Abhyanker, Cupertino, CA (US)

(21) Appl. No.: 14/288,417

(22) Filed: May 28, 2014

Related U.S. Application Data
(63) Continuation-in-part of application No. 14/157,540, filed on Jan. 17, 2014.
Application No. 14/157,540 is a continuation-in-part of application No. 14/207,679, filed on Mar. 13, 2014.
Application No. 14/207,679 is a continuation-in-part of application No. 14/203,531, filed on Mar. 10, 2014, now Pat. No. 8,775,328.
Application No. 14/203,531 is a continuation of application No. 11/653,194, filed on Jan. 12, 2007.
Application No. 11/653,194 is a continuation-in-part of application No. 11/603,442, filed on Nov. 22, 2006, now abandoned.
(60) Provisional application No. 60/783,226, filed on Mar. 17, 2006.

(51) Int. Cl. G06Q 10/08

(52) U.S. Cl. CPC G06Q 10/08355
USPC 701/3; 701/23

(57) ABSTRACT

A method and system of landing site designation in an autonomous delivery network are disclosed. In one embodiment, a landing server marks a geo-spatial location as an autonomous delivery location upon receiving a designation data communicated through a network by a recipient user. The designation data indicates the geo-spatial location as the autonomous delivery location based on at least one of a current geospatial location of a mobile device of the recipient user and a map view marking created by the recipient user through a computing device. The autonomous delivery location is associated with the recipient user and a navigation data is communicated through the network to an autonomous vehicle, directing the autonomous vehicle to the autonomous delivery location of the recipient user when a payload is requested by any one of the recipient user and a sending user to be physically delivered to the autonomous delivery location.

### CLAIMS OF PRIORITY

This patent application is a continuation and continuation in part, claims priority from, and hereby incorporates by reference and claims priority from the entirety of the disclosures of the following cases and each of the cases on which they depend and further claim priority or incorporate by reference:
(1) U.S. Utility patent application Ser. No. 14/157,540 titled AUTONOMOUS NEIGHBORHOOD VEHICLE COMMERCE NETWORK AND COMMUNITY, filed Jan. 17, 2014.
(2) U.S. Utility patent application Ser. No. 14/207,679 titled PEER-TO-PEER NEIGHBORHOOD DELIVERY MULTI-COPTER AND METHOD, filed Mar. 13, 2014.
(3) U.S. Continuation patent application Ser. No. 14/203,531 titled ‘GEO-SPATIALLY CONSTRAINED PRIVATE NEIGHBORHOOD SOCIAL NETWORK’ filed on Mar. 10, 2014, which is a continuation of U.S. patent application Ser. No. 11/653,194 titled ‘LODGING AND REAL PROPERTY IN A GEO-SPATIAL MAPPING ENVIRONMENT’ filed on Jan. 12, 2007, which further depends on U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006, U.S. Provisional patent application No. 60/817,470, titled ‘SEGMENTED SERVICES HAVING A GLOBAL STRUCTURE OF NETWORKED INDEPENDENT ENTITIES’, filed Jun. 28, 2006, U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006, U.S. Provisional patent application No. 60/854,230, titled ‘METHOD AND APPARATUS OF NEIGHBORHOOD EXPRESSION AND USER CONTRIBUTION SYSTEM’ filed on Oct. 25, 2006, and U.S. Utility patent application Ser. No. 11/603,442 titled ‘MAP BASED NEIGHBORHOOD SEARCH AND COMMUNITY CONTRIBUTION’ filed on Nov. 22, 2006.

### FIELD OF TECHNOLOGY

This disclosure relates generally to the technical fields of communications and, in one example embodiment, to a method, apparatus, and system of landing site designation in an autonomous delivery network.

### BACKGROUND

Individuals and/or commerce entities (e.g., restaurants, retail stores, food sellers, and/or delivery services) may wish to engage in deliveries made by autonomous vehicles. Deliveries made by autonomous vehicles may be unreliable and/or unsafe as delivery locations may be large and/or vague (e.g., an address and/or or place name). This may cause deliveries to be made to suboptimal locations (e.g., roof tops, parking lots, and/or lawns), may put people and/or property around the delivery location in danger, and/or may cause damage to the autonomous vehicle and/or its contents.

### SUMMARY

A method and system of landing site designation in an autonomous delivery network are disclosed. In one aspect, a method of a landing server includes marking, using a processor and a memory, a geo-spatial location in a radial vicinity encompassing the geo-spatial location as an autonomous delivery location upon receiving a designation data indicating the geo-spatial location is the autonomous delivery location. The designation data is communicated to the landing server through a network by a recipient user of an autonomous delivery network. The recipient user indicates the geo-spatial location as the autonomous delivery location based on at least one of a current geospatial location of a mobile device of the recipient user and a map view marking created by the recipient user through a computing device. The autonomous delivery location is associated with the recipient user of the autonomous delivery network. A navigation data is communicated through the network to an autonomous vehicle to direct the autonomous vehicle to the autonomous delivery location of the recipient user when a payload associated with the autonomous vehicle is requested by any one of the recipient user and a sending user to be physically delivered to the autonomous delivery location.

It may be determined that the recipient user lives at a residence associated with a claimable residential address of the autonomous delivery network formed through a social community algorithm of a privacy server using a processor and a memory. The autonomous delivery location may be verified to be encompassed by a tract boundary of the residence prior to the landing server accepting the geo-spatial location as the autonomous delivery location. It may be determined that the recipient user is associated with a public address associated with a claimable public address of the autonomous delivery network formed through the social community algorithm of the privacy server using the processor and the memory. The autonomous delivery location may be verified to be encompassed by the tract boundary of the public address prior to accepting the geo-spatial location as the autonomous delivery location. The autonomous delivery network may automatically notify the recipient user at a time when the payload is delivered to a residential address and/or the public address. The public address may be a work address, a park address, a public forum address, and/or a community center address.

The current geospatial location of the mobile device may be determined. The current geospatial location of the mobile device may be associated with the autonomous delivery location in the radial vicinity encompassing the current geospatial location of the mobile device when the recipient user of the mobile device requests the current geospatial location of their mobile device as the autonomous delivery location.

The autonomous delivery location may not be more than five meters in radial diameter from an epicenter associated with the current geospatial location. The autonomous delivery location may be associated with the recipient user of the autonomous delivery network. The autonomous vehicle may be directed to the autonomous delivery location when the sending user places the payload in the autonomous vehicle in route to the recipient user through the autonomous delivery network. The sending user may be a merchant, a neighbor, and/or a friend user.

The recipient user may be permitted to grant a friend user of the recipient user in the autonomous delivery network permission to use the autonomous delivery location of the recipient user. The recipient user and/or the friend user may be notified when another payload requested by the friend user from the sending user is delivered to the autonomous delivery location based on a request of the friend user to deliver the another payload to the autonomous delivery location. It may be automatically determined that the autonomous delivery location is currently being occupied by another autonomous vehicle and/or otherwise obstructed. A message may be sent to the autonomous vehicle to wait until the autonomous delivery location is freed from obstruction. The recipient user may be optionally notified when the autonomous delivery location is obstructed.

The recipient user may be permitted to select when the autonomous delivery location is online and/or offline. The autonomous vehicle may be instructed to deliver the payload only when the autonomous delivery location is online. The recipient user may be requested to verify that the autonomous delivery location is on a level ground and/or free from any land obstructions including a building, a tree, a blockage, a fence, and/or any land-based hazardous conditions. The recipient user may be requested to verify that an associated airspace in which the autonomous vehicle traverses above the autonomous delivery location is free from any aerial obstructions including a power line, a utility pole, a telephone line, a utility line, and/or any other aerial hazard condition. The autonomous delivery location may be associated with a private neighborhood social network in which each user is verified based on an address data and in which each user is able to designate certain information as being private.

It may be automatically requested that the autonomous vehicle take a photograph to confirm a successful delivery of the payload at the autonomous delivery location. The photograph may be communicated to the recipient user when the successful delivery of the payload is made to provide proof of delivery. The mobile device may be a mobile phone, a landing beacon device, and/or a landing pod. The autonomous vehicle may be a rover vehicle, an autonomous robot, an autonomous bicycle, a quadcopter, an octocopter, a multirotor aircraft, and/or a fixed wing aircraft.

The autonomous delivery location may be a node in a chain of nodes between an origin location and a destination location. The autonomous vehicle may be commissioned by the sending user to utilize the autonomous delivery location as a waypoint in route to the destination location. A network of autonomous robots may operate in concert to shuttle the payload from the origin location to the destination location through the chain of nodes including the node serving as the waypoint being the autonomous delivery location.

In another aspect, a method of a landing server includes marking, using a processor and a memory, a geo-spatial location in a radial vicinity encompassing the geo-spatial location as an autonomous delivery location upon receiving a designation data indicating the geo-spatial location is the autonomous delivery location. The recipient user indicates the geo-spatial location as the autonomous delivery location based on at least one of a current geospatial location of a mobile device of the recipient user and a map view marking created by the recipient user through a computing device. The autonomous delivery location is associated with the recipient user of the autonomous delivery network. It is determined determining that the recipient user lives at a residence associated with a claimable residential address of the autonomous delivery network formed through a social community algorithm of a privacy server, using a processor and a memory. The autonomous delivery location is verified to be encompassed by a tract boundary of the residence prior to accepting the geo-spatial location as the autonomous delivery location.

A navigation data may be communicated, through a network, to an autonomous vehicle to direct the autonomous vehicle to the autonomous delivery location of the recipient user when a payload associated with the autonomous vehicle is requested by any one of the recipient user and a sending user to be physically delivered to the autonomous delivery location.

In yet another aspect, an autonomous delivery network includes a network and at least one of a mobile device and a computing device associated with a recipient user of an autonomous delivery network to communicate a designation data indicating a geo-spatial location is an autonomous delivery location. The recipient user indicates the geo-spatial location as the autonomous delivery location based on at least one of a current geospatial location of the mobile device of the recipient user and a map view marking created by the recipient user through the computing device. The autonomous delivery network further includes a landing server, including a processor and a memory, communicatively coupled with at least one of the mobile device and the computing device through the network. The landing server is configured to mark the geo-spatial location as the autonomous delivery location upon receipt of the designation data, associate the autonomous delivery location with the recipient user of the autonomous delivery network, and communicate a navigation data to an autonomous vehicle to direct the autonomous vehicle to the autonomous delivery location of the recipient user when a payload associated with the autonomous vehicle is requested by any one of the recipient user and a sending user to be physically delivered to the autonomous delivery location.

A residence algorithm may determine that the recipient user lives at a residence associated with a claimable residential address of the autonomous delivery network formed through a social community algorithm of a privacy server using a processor and a memory. A verification algorithm may verify the autonomous delivery location is encompassed by a tract boundary of the residence and/or a public address prior to accepting the geo-spatial location as the autonomous delivery location. A public address algorithm may determine that the recipient user is associated with the public address associated with a claimable public address of the autonomous delivery network formed through the social community algorithm of the privacy server using the processor and the memory. A recipient notification algorithm may automatically notify the recipient user at a time when the payload is delivered to a residential address and/or the public address. The public address may be a work address, a park address, a public forum address, and/or a community center address. The recipient user may indicate the geo-spatial location as the autonomous delivery location based on a current geospatial location of the mobile device of the recipient user and/or a map view marking created by the recipient user through the computing device.

A current location algorithm may determine the current geospatial location of the mobile device. An association algorithm may associate the current geospatial location of the mobile device with the autonomous delivery location in a radial vicinity encompassing the current geospatial location of the mobile device when the recipient user of the mobile device requests the current geospatial location of their mobile device as the autonomous delivery location. The autonomous delivery location may be less than five meters in radial diameter from an epicenter associated with the current geospatial location.

A location association algorithm may associate the autonomous delivery location with the recipient user of the autonomous delivery network. A navigation algorithm may direct the autonomous vehicle to the autonomous delivery location when a sending user places the payload in the autonomous vehicle in route to the recipient user through the autonomous delivery network. The sending user may be a merchant, a neighbor, and/or a friend user.

A share algorithm may permit the recipient user to grant a friend user of the recipient user in the autonomous delivery network permission to use the autonomous delivery location of the recipient user. A friend notification algorithm may notify the recipient user and/or the friend user when another payload requested by the friend user from the sending user is delivered to the autonomous delivery location based on a request of the friend user to deliver the another payload to the autonomous delivery location. An occupied algorithm may automatically determine that the autonomous delivery location is currently being occupied by another autonomous vehicle and/or otherwise obstructed. A wait algorithm may send a message to the autonomous vehicle to wait until the autonomous delivery location is freed from obstruction. An obstruction algorithm may optionally notify the recipient user when the autonomous delivery location is obstructed.

An online algorithm may permit the recipient user to select when the autonomous delivery location is online. An offline algorithm may permit the recipient user to select when the autonomous delivery location is offline. A restriction algorithm may instruct the autonomous vehicle to deliver the payload only when the autonomous delivery location is online. A ground safety algorithm may request that the recipient user verifies that the autonomous delivery location is on a level ground and free from any land obstructions including a building, a tree, a blockage, a fence, and/or any land-based hazardous conditions. An aerial safety algorithm may request that the recipient user verifies that an associated airspace in which the autonomous vehicle traverses above the autonomous delivery location is free from any aerial obstructions including a power line, a utility pole, a telephone line, a utility line, and/or any other aerial hazard condition.

A photo algorithm may automatically request that the autonomous vehicle take a photograph to confirm a successful delivery of the payload at the autonomous delivery location. A confirmation algorithm may communicate the photograph to the recipient user when the successful delivery of the payload is made to provide proof of delivery. The mobile device may be a mobile phone, a landing beacon device, and/or a landing pod. The autonomous vehicle may be a rover vehicle, an autonomous robot, an autonomous bicycle, a quadcopter, an octocopter, a multirotor aircraft, and/or a fixed wing aircraft.

The autonomous delivery location may be a node in a chain of nodes between an origin location and a destination location. The autonomous vehicle may be commissioned by the sending user to utilize the autonomous delivery location as a waypoint in route to the destination location. A network of autonomous robots may operate in concert to shuttle the payload from the origin location to the destination location through the chain of nodes including the node serving as the waypoint being the autonomous delivery location.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 shows an autonomous delivery network with a mobile device communicating a designation data to a landing server, indicating that a geo-spatial location is an autonomous delivery location, according to one embodiment.

FIG. 2 is an exploded view of the landing server of FIG. 1, according to one embodiment.

FIG. 3 is a designation view of a recipient user designating an autonomous delivery location with a map view marking using a computing device, according to one embodiment.

FIG. 4 is a table view illustrating data relationships between recipient users, friend users, and autonomous delivery locations, according to one embodiment.

FIG. 5 is a user interface view of the mobile device of FIG. 1 requesting a payload be delivered to the residential autonomous delivery location of the recipient user, according to one embodiment.

FIG. 6 is a notification view of the mobile device of FIG. 5 receiving a notification including a photograph as proof of a successful delivery, according to one embodiment.

FIG. 7 is an autonomous delivery location sharing view of a message being sent to an autonomous vehicle indicating that the autonomous delivery location is occupied, according to one embodiment.

FIG. 8 is a user interface view of the mobile device of the recipient user of FIG. 1 selecting when the autonomous delivery location is online and offline, according to one embodiment.

FIG. 9 is a critical path view illustrating a flow based on time in which critical operations in designating the autonomous delivery location of FIG. 1 and delivering a payload are established, according to one embodiment.

FIG. 10A is a process flow of designating an autonomous delivery location of FIG. 1 and delivering a payload to the autonomous delivery location of FIG. 1, according to one embodiment.

FIG. 10B is a continuation of the process flow of FIG. 10A showing additional processes, according to one embodiment.

FIG. 11 is a landing condition view of the autonomous vehicle of FIG. 1 attempting to land at an obstructed autonomous delivery location, according to one embodiment.

FIG. 12 is a node system view of a network of autonomous robots working in concert to transport a payload across a chain of nodes serving as waypoints between an original location and a destination location, according to one embodiment.

FIG. 13 is a neighborhood view of an autonomous delivery location being designated, using a mobile device, in a neighborhood having other autonomous delivery locations, according to one embodiment.

Other features of the present embodiments will be apparent from the accompanying drawings and from the detailed description that follows.

### DETAILED DESCRIPTION

Disclosed are a method and system of landing site designation in an autonomous delivery network 150, according to one embodiment.

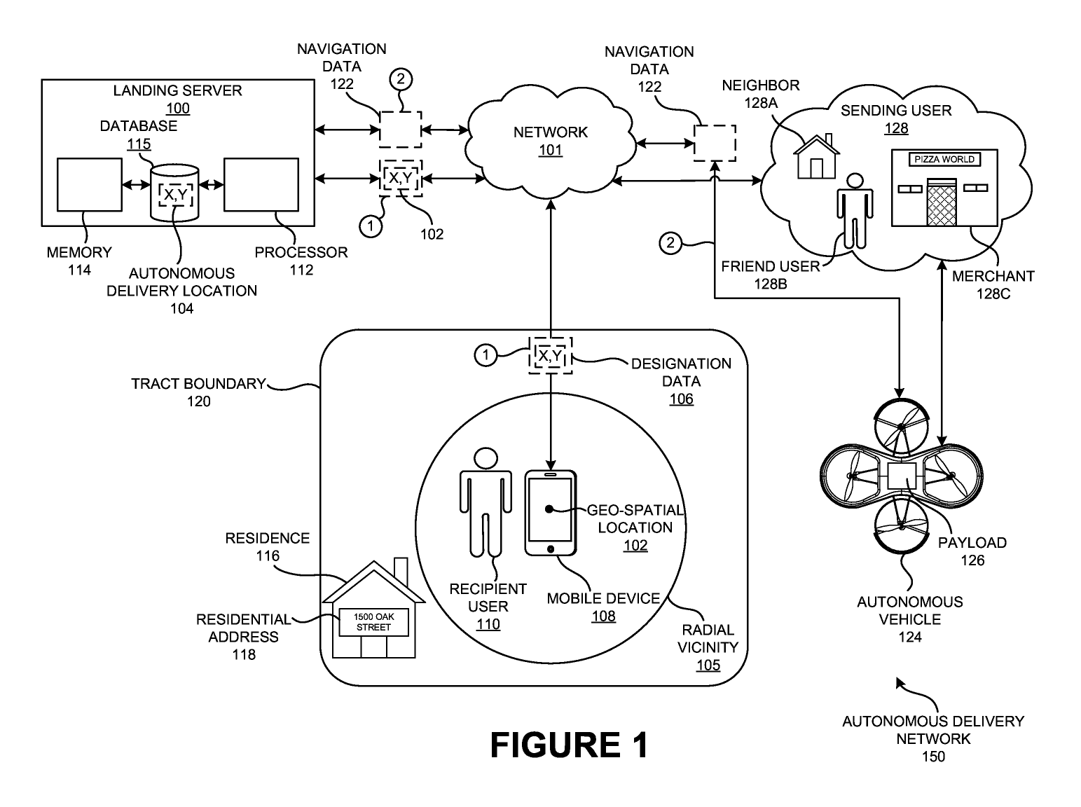

FIG. 1 shows an autonomous delivery network with a mobile device communicating a designation data to a landing server, indicating that a geo-spatial location is an autonomous delivery location, according to one embodiment. In particular, FIG. 1 shows the landing server 100, a network 101, a geo-spatial location 102, an autonomous delivery location 104, a radial vicinity 105, a designation data 106, a mobile device 108, a recipient user 110, a memory 114, a processor 112, a database 115, a residence 116, a residential address 118, a tract boundary 120, a navigation data 122, a payload 126, a sending user 128, a neighbor 128A, a friend user 128B, and a merchant 128C.

The landing server 100 may include the processor 112, the memory 114, and/or the database 115. The landing server 100 may be one or more server side data processing systems (e.g., web servers operating in concert with each other) that operate in a manner that provide a set of instructions to any number of client side devices (e.g., a device (e.g., the mobile device 108)) communicatively coupled with the landing server 100 through the network 101. For example, the landing server 100 may be a computing system (e.g., or a group of computing systems) that operates in a larger client-server database framework (e.g., such as in a social networking software such as Nextdoor.com, Fatdoor.com, Facebook.com, etc.).

The mobile device 108 (e.g., a landing beacon, a landing pod, a smartphone, a tablet, and/or a portable data processing system) may access the landing server 100 through the network 101 using a browser application of the mobile device 108 (e.g., Google®, Chrome) and/or through a client-side application downloaded to the mobile device 108 (e.g., a Nextdoor.com mobile application, a Fatdoor.com mobile application) operated by the recipient user 110. In an alternate embodiment, a computing device 300 (e.g., a non-mobile computing device, a laptop computer, and/or a desktop computer) may access the landing server 100 through the network 101.

FIG. 1 illustrates a number of operations between the landing server 100, the mobile device 108, the recipient user 110 and/or the sending user 128, and the autonomous vehicle 124. Particularly, circle ‘1’ of FIG. 1 illustrates the mobile device 108 of the recipient user 110 communicating, through the network 101 (e.g., an Internet protocol network and/or a wide area network), the designation data 106 to the landing server 100, thereby indicating that the geo-spatial location 102 (e.g., a set of geo-spatial coordinates and/or the current geospatial location of the mobile device 108) is the autonomous delivery location 104. The designation data 106 may include a set of geo-spatial coordinates (e.g., the geo-spatial location 102 (e.g., the current geospatial location of the mobile device 108)). In one embodiment, the landing server 100 may mark the geo-spatial location 102 as the autonomous delivery location 104 and/or associate the autonomous delivery location 104 with the recipient user 110 (e.g., the recipient user 110 that sent the designation data 106, the recipient user 110 associated with the residence 116 associated with the geo-spatial location 102 (e.g., the residence 116 containing the geo-spatial location 102 in its tract boundary 120), and/or a profile associated with the recipient user 110). The autonomous delivery location 104 may be stored in the database 115 (e.g., in a table of the database 115).

A user (e.g., the recipient user 110) may be able to generate the designation data 106 using the mobile device 108 (e.g., the mobile device 108 associated with the user) using a selection means (e.g., by pressing a button, selecting an icon on a touch screen, and/or using a voice command) of the mobile device 108 that captures the geo-spatial location 102 (e.g., the current geospatial location and/or geo-spatial coordinates) of the mobile device 108 and/or indicates that the geo-spatial location 102 (e.g., the current geospatial location of the mobile device 108) is the autonomous delivery location 104. In one embodiment, the user may be able to select the geo-spatial location 102 in a map view 302 through the computing device 300 and/or mobile device 108.

The geo-spatial location 102 and/or radial vicinity 105 (e.g., the entirety of the radial vicinity 105 and/or a portion of the radial vicinity 105) may be required to be located in the tract boundary 120 associated with the residence 116 (e.g., a claimable residence 116) and/or the residential address 118 (e.g., a claimable residential address 118) associated with the user. The radial vicinity 105 may have a radius of 2.5 meters, 5 meters, or a distance sufficient to create an associated area enclosed by the circumference created by the radius vicinity sufficient to encompass the entirety of the autonomous vehicle 124 and/or the payload 126 associated therewith, according to one embodiment. The radial vicinity 105 may depend upon the accuracy of the GPS network employed by the autonomous delivery network 150 (e.g., the autonomous vehicle 124, the mobile device 108, and/or landing server 100 of the autonomous delivery network 150).

In one embodiment, the tract boundary 120 may be determined by the user and/or the autonomous delivery network 150. The tract boundary 120 may be determined entirely or in part by a data provider (e.g., Zillow.com, a white pages service, a government entity, official records, a deed, and/or a lease) and/or a vote. The tract boundary 120 may be the boundary of the property (e.g., the residence 116 and/or an office).

In one embodiment, users (e.g., recipient users 110 and/or sending users 128) may be able to designate multiple autonomous delivery locations 104. Users may select one or more autonomous delivery locations 104 for one or more public addresses 402 (e.g., work addresses) and/or one or more residential addresses 118 (e.g., home addresses). In one embodiment, users of the autonomous delivery network 150 may be able to use (e.g., rent, share, and/or borrow) autonomous delivery locations 104 of other users.

Autonomous delivery locations 104 may be separated into categories such as “Private” (e.g., associated with a residence 116 and/or a residential address 118), “Semi-private” (e.g., associated with a multi-resident address), and/or “Public” (e.g., associated with a public location (e.g., a park, a public forum, and/or a community center)). For example, a user (e.g., the recipient user 110) living in an apartment complex may be able to designate a “Private” autonomous delivery location on a porch of their apartment (e.g., a porch within the tract boundary 120 associated with their apartment. The user may be able to designate a “Private” autonomous delivery location with the radial vicinity 105 contained in a parking spot assigned to the user (e.g., through a lease). The autonomous delivery location 104 may be required to be free from land and/or air-based obstructions (e.g., a car, an overhang, and/or trees 1104).

In one embodiment, the user (e.g., the recipient user 110) may designate a “Semi-private” autonomous delivery location in their apartment complex. In one embodiment, the user may designate their autonomous delivery location 104 on a patch of grass within a tract boundary 120 of the apartment complex in which they live. The apartment complex (e.g., the owner and/or landlord) may be required to give permission before the geo-spatial location 102 is marked as the autonomous delivery location 104. The user may share the autonomous delivery location 104 and/or patch of grass with other users (e.g., other users in their building 1102). In one embodiment, the “Semi-private” autonomous delivery location may be used for other purposed (e.g., a basketball court) on a regular basis. The user may be required to occupy the “Semi-private” autonomous delivery location and/or be within eye sight of the “Semi-private” autonomous delivery location for a delivery to be made. The user may need to certify that the “Semi-private” autonomous delivery location is free from obstructions and/or the autonomous vehicle 124 is safe to arrive at and/or occupy the autonomous delivery location 104 (e.g., the user may be required to sign a release taking responsibility (e.g., full responsibility) for any damage and/or injury caused while the autonomous delivery is being made). The mobile device 108 associated with the user (e.g., the recipient user 110) may be required to be located at and/or near (e.g., within 5 meters) the “Semi-private” autonomous delivery location.

In one embodiment, a user (e.g., the recipient user 110) may designate a “Public” autonomous delivery location in an area for use by the public (e.g., a park and/or a public school). The “Public” autonomous delivery location may be restricted to certain public areas (e.g., may not be permitted to be in a street and/or a sidewalk). The “Public” autonomous delivery location may only be online while the public area is available to the public. For example, a “Public” autonomous delivery location in a park may not be accessible after the park has closed for the day/evening. The user may need to certify that the “Public” autonomous delivery location is free from obstructions and/or the autonomous vehicle 124 is safe to land and/or occupy the delivery location (e.g., the user may be required to sign a release taking responsibility (e.g., full responsibility) for any damage and/or injury caused while the autonomous delivery is being made). The mobile device 108 associated with the user (e.g., the recipient user 110) may be required to be located at and/or near (e.g., within 5 meters) the “Public” autonomous delivery location when the delivery is requested and/or for any period of time from when the delivery is requested until the delivery is completed.

Users may not be able to designate their own “Public” and/or “Semi-private” autonomous delivery locations. In one embodiment, multi-resident addresses, public areas, and/or other locations conducent to “Public” and/or “Semi-private” autonomous delivery locations may have one or more designated “Public” and/or “Semi-private” autonomous delivery locations made available to recipient users 110. Recipient users associated with such locations (e.g., having a verified residential address 118 (e.g., an apartment) associated with the location and/or currently located at the public area (e.g., park) may be able to use one or more pre-designated “Public” and/or “Semi-private” autonomous delivery locations but may not be able to designate their own.

Circle ‘2’ shows the navigation data 122 being sent through the network 101 to the autonomous vehicle 124. The autonomous vehicle 124 may be an aerial vehicle (e.g., a helicopter, a multi rotor copter (e.g., a quadcopter and/or an octocpoter), and/or a fixed wing aerial vehicle), a land-based vehicle (e.g., a single wheel vehicle, a multi wheel vehicle, a rover vehicle, a car, an autonomous bicycle, an autonomous land-based robot), and/or an aquatic vehicle (e.g., a boat and/or a submarine). It will be appreciated that the present disclosure may be applied to designation of land, air, and aquatic autonomous delivery locations 104.

In one embodiment, the navigation data 122 may be generated by the landing server 100 using the processor 112, the memory 114, and/or the database 115. The navigation data 122 may be generated and/or communicated in response to the receipt of a request 304 (e.g., an order and/or a request 304 for a payload delivery) from the recipient user 110 and/or the sending user 128 (e.g., the neighbor 128A, the friend user 128B (e.g., a user of the autonomous delivery network 150 with whom the recipient user 110 has indicated a relationship), and/or the merchant 128C). The navigation data 122 may be communicated continuously and/or updated. The landing server 100 may work in concert with the autonomous vehicle 124 (e.g., adapting the navigation data 122 to take into account information from the autonomous vehicle 124 (e.g., obstacles sensed, amount of power remaining, and/or settings of the autonomous vehicle 124)), a GPS network of the autonomous delivery network 150 (not shown), and/or a cellular network of the autonomous delivery network 150 (not shown). The GPS network and/or cellular network may be communicatively couple with the landing server 100, the mobile device 108, the computing device 300, and/or the autonomous vehicle 124.

The navigation data 122 may be a set of destination coordinates, a set of way-point coordinates, and/or continuously adjusted instructions. In one embodiment, the navigation instructions may direct the autonomous vehicle 124 to a first autonomous delivery location associated with the requested payload 126. For example, the autonomous vehicle 124 may be directed to the merchant 128C from whom the payload 126 is requested. The navigation data 122 may then direct the autonomous vehicle 124 to a second autonomous delivery location associated with the recipient user 110 (e.g., the user that requested the payload 126 from the merchant 128C) and/or a new set of navigation data 122 may be generated to direct the autonomous vehicle 124 from the first autonomous delivery location to the second autonomous delivery location. A navigation algorithm 216 of the landing server 100 may direct the autonomous vehicle 124 and/or generate the navigation data 122.

In one embodiment, confirmation that the autonomous vehicle 124 has the payload 126 and/or is ready to continue with the delivery may be required before the autonomous vehicle 124 is directed from the first autonomous delivery location to the second autonomous delivery location. The confirmation may be an indication (e.g., a selection of an indication means (e.g., button) made on the autonomous vehicle 124 and/or an indication made on a device (e.g., the mobile device 108 and/or the computing device 300 of the sending user 128) of the merchant 128C (e.g., sending user 128)) that the payload 126 has been affixed to the autonomous vehicle 124.

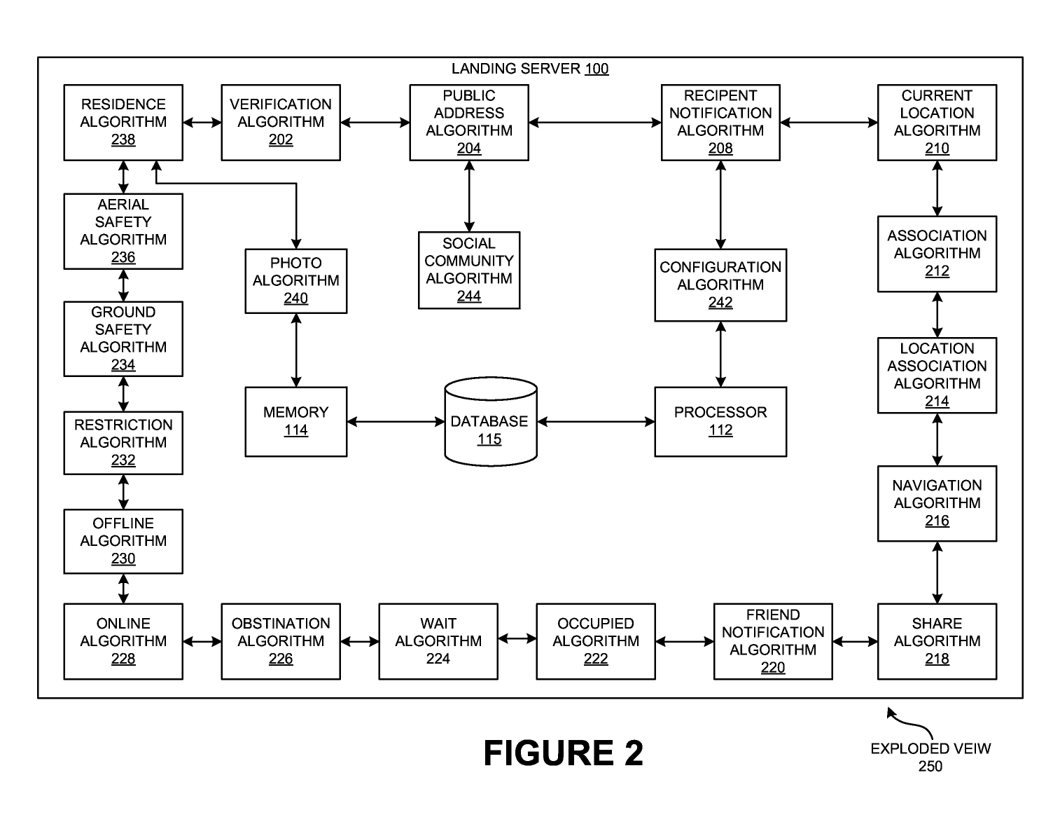

FIG. 2 is an exploded view 250 of the landing server of FIG. 1, according to one embodiment. FIG. 2 shows a verification algorithm 202, a public address algorithm 204, a recipient notification algorithm 208, a current location algorithm 210, an association algorithm 212, a location association algorithm 214, a navigation algorithm 216, a share algorithm 218, a friend notification algorithm 220, an occupied algorithm 222, a wait algorithm 224, an obstruction algorithm 226, an online algorithm 228, an offline algorithm 230, a restriction algorithm 232, a ground safety algorithm 234, an aerial safety algorithm 236, a residence algorithm 238, a photo algorithm 240, a configuration algorithm 242, and a social community algorithm 244.

In one embodiment, the verification algorithm 202 may verify that the autonomous delivery location 104 is encompassed (e.g., entirely encompassed and/or partially encompassed) by the tract boundary 120 of the residence 116 and/or a public address 402 associated with the recipient user 110 (e.g., the recipient user 110 indicating that the geo-spatial location 102 is the autonomous delivery location 104 through the designation data 106). Successful verification that that the geo-spatial location 102 will meet a requirement of encompassment (e.g., all and/or a portion of the autonomous delivery location 104 and/or radial vicinity 105 will be encompassed in the tract boundary 120) may be required before the geo-spatial location 102 is accepted (e.g., marked) as the autonomous delivery location 104. The verification algorithm 202 may also require additional considerations be met and/or verified before the geo-spatial location 102 may be marked as the autonomous delivery location 104. For example, it may need to be verified that the user (e.g., the user sending the designation data 106 and/or the recipient user 110) has read and/or agreed to terms of use of the autonomous delivery network 150 and/or has agreed to take responsibility for keeping the selected geo-spatial location 102 free from obstruction and/or safe for landing (e.g., arrival of the autonomous vehicle 124).

The residence algorithm 238 may determine that the recipient user 110 lives at a residence 116 associated with the claimable residential address 118 (e.g., the residential address 118) of the autonomous delivery network 150. The autonomous delivery network 150 may be formed through a social community algorithm of the landing server 100 and/or a privacy server. The public address algorithm 204 may determine that the recipient user 110 is associated with (e.g., has a claimed address in the same a neighborhood as, is currently located in, and/or is, lives and/or works within a threshold distance from) the public address 402 associated with the claimable public address 402 of the autonomous delivery network 150. In one embodiment, the user may need to be granted access (e.g., granted guest access through the autonomous delivery network 150) in order to designate an autonomous delivery location 104 associated with the public address 402. The user may only be permitted to use the autonomous delivery location 104 associated with the public address 402 under certain circumstances (e.g., at certain times, on certain days, and/or while currently at the public address 402).

The recipient notification algorithm 208 may automatically notify the recipient user 110 at a time (e.g., when the autonomous vehicle 124 is a certain time away and/or when the autonomous vehicle 124 has arrived) when the payload 126 is delivered and/or is being delivered to the autonomous delivery location 104 associated with the residential address 118 and/or the public address 402. In one embodiment, the recipient notification algorithm 208 may notify the recipient user 110 (e.g., the mobile device 108 and/or computing system of the recipient user 110) at a specified (e.g., specified by the recipient user 110, sending user 128, and/or landing server 100) time before arrival, distance from arrival, and/or time elapsed in transit. The current location algorithm 210 may determine the current geospatial location of the mobile device 108. The current location algorithm 210 may work in concert with the GPS network, cellular network, and/or the mobile device 108.

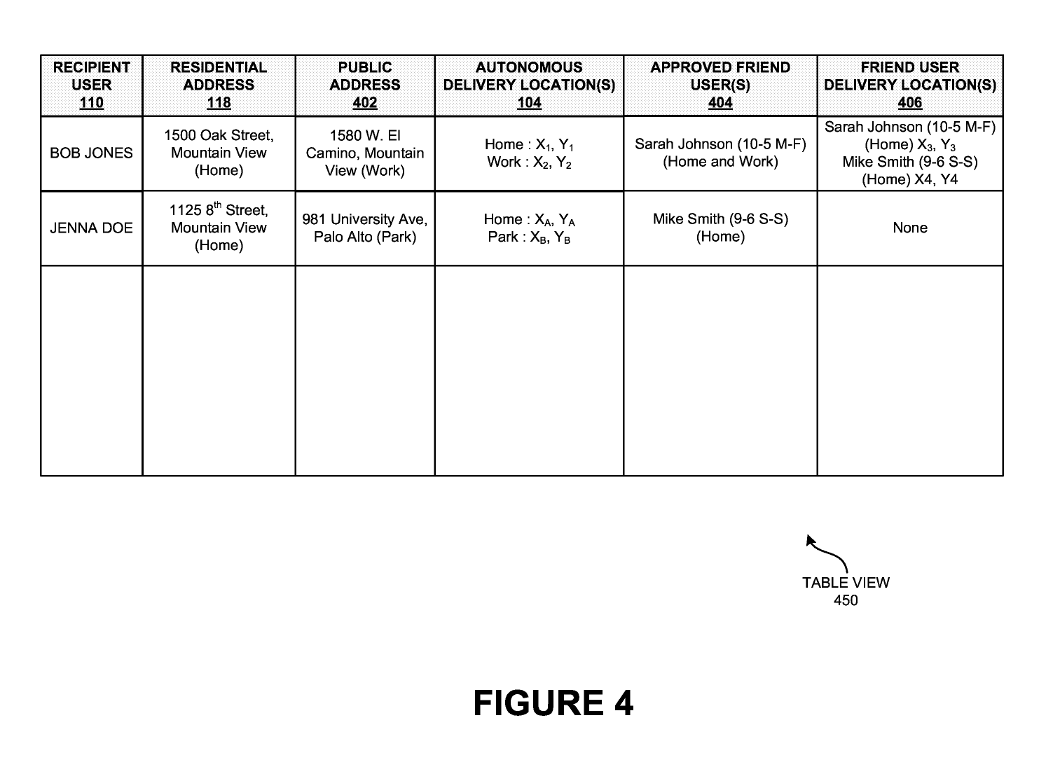

The association algorithm 212 may work in concert with the current location algorithm 210 and/or associate the current geospatial location (e.g., the geo-spatial location 102) of the mobile device 108 with the autonomous delivery location 104 in the radial vicinity 105 encompassing the current geospatial location when the recipient user 110 of the mobile device 108 requests 304 the current geospatial location be marked as the autonomous delivery location 104. The association algorithm 212 may associate and/or store the current geospatial location (e.g., the geo-spatial location 102) as the autonomous delivery location 104 of the recipient user 110 in the database 115. The location association algorithm 214 may associate the autonomous delivery location 104 with the recipient user 110 of the autonomous delivery network 150. In one embodiment, the autonomous delivery location 104 and/or its association with the recipient user 110 may be stored in a table of the database 115 (e.g., the table of FIG. 4).

The navigation algorithm 216 may direct the autonomous vehicle 124 to the autonomous delivery location 104 when a sending user 128 places the payload 126 in the autonomous vehicle 124 in route to the recipient user 110 through the autonomous delivery network 150. In one embodiment, the navigation algorithm 216 may generate and/or communicate the navigation data 122 through the network 101 to the autonomous vehicle 124. The navigation algorithm 216 may direct the autonomous vehicle 124 from its current location to the autonomous delivery location 104 of the sending user 128 before directing the autonomous vehicle 124 to the autonomous delivery location 104 of the recipient user 110.

A share algorithm 218 may permit the recipient user 110 to grant a friend user 128B permission to use the autonomous delivery location 104 of the recipient user 110. The friend notification algorithm 220 may notify the recipient user 110 and/or the friend user 128B when a payload 126 requested by the friend user 128B to be delivered at the autonomous delivery location 104 of the recipient user 110 is delivered to the autonomous delivery location 104 of the recipient user 110. In one embodiment, the friend notification algorithm 220 may communicate notifications 600 to the recipient user 110 and/or the friend user 128B at a specified time until arrival (e.g., specified by the recipient user 110, sending user 128, friend user 128B, and/or landing server 100), distance from arrival, and/or time elapsed in transit.

The occupied algorithm 222 may automatically determine if the autonomous delivery location 104 is currently being occupied by an autonomous vehicle 124 of the autonomous delivery network 150 and/or otherwise obstructed. The occupied algorithm 222 may determine if another delivery is scheduled at the autonomous delivery location 104 within a threshold amount of time before the delivery is scheduled. The wait algorithm 224 may instruct the autonomous vehicle 124 (e.g., send a message to the autonomous vehicle 124) to loiter and/or delay the delivery until it has been determined that the autonomous delivery location 104 will be safely clear when the autonomous vehicle 124 arrives. The obstruction algorithm 226 may notify the recipient user 110 when the autonomous delivery location 104 is obstructed and/or if there is a delay instructed by the wait algorithm 224. The autonomous delivery location may be associated with a private neighborhood social network in which each user is verified based on an address data and in which each user is able to designate certain information as being private (see patent applications whose disclosure herein is incorporated by reference).

The online algorithm 228 may permit the recipient user 110 to select when the autonomous delivery location 104 is online. The offline algorithm 230 may permit the recipient user 110 to select when the autonomous delivery location 104 is offline. In one embodiment, a selection of times when the autonomous delivery location 104 is online may also select when the autonomous delivery location 104 is offline by default (and vice versa). The online algorithm 228 and/or offline algorithm 230 may also permit the recipient user 110 to select when the autonomous delivery location 104 is online/offline for friend users 128B that have been cleared to use the autonomous delivery location 104 of the recipient user 110.

The restriction algorithm may instruct 232 (e.g., constrain) the autonomous vehicle 124 to deliver the payload 126 only when the autonomous delivery location 104 is online. The ground safety algorithm 234 may request 304 and/or require the recipient user 110 (e.g., the user associated with the autonomous delivery location 104 the autonomous vehicle 124 will arrive at) verify that the autonomous delivery location 104 is on level ground 1110 (e.g., a level surface) and/or free from any land obstructions (e.g., a building 1102, a bush, a tree 1104, a fence 1108, a blockage 1106, a person, an animal, a car, and/or a piece of lawn furniture). The recipient user 110 may need to verify that the autonomous delivery location 104 is clear from any such obstructions before the delivery may be started and/or made. In one embodiment, the user may need to ensure and/or verify that there is a path (e.g., a designated path) making the autonomous delivery location 104 accessible from a street, sidewalk, and/or other means of travel capable by the autonomous vehicle 124 that is clear of any obstructions.

The aerial safety algorithm 236 may request 304 and/or require the recipient user 110 verifies that an associated airspace in which the autonomous vehicle 124 traverses above the autonomous delivery location 104 is free from any aerial obstructions (e.g., a power line, a utility pole 1114, a utility line, and/or an overhang) that may prevent the autonomous vehicle 124 from reaching the autonomous delivery location 104 safely and without causing any damage to itself, the payload 126 and/or obstructions. The photo algorithm 240 may request 304 and/or instruct the autonomous vehicle 124 to take a photograph 604 to confirm a successful delivery 602 of the payload 126. The confirmation algorithm may communicate the photograph 604 to the recipient user 110 when the successful delivery 602 of the payload 126 is made in order to provide proof of delivery.

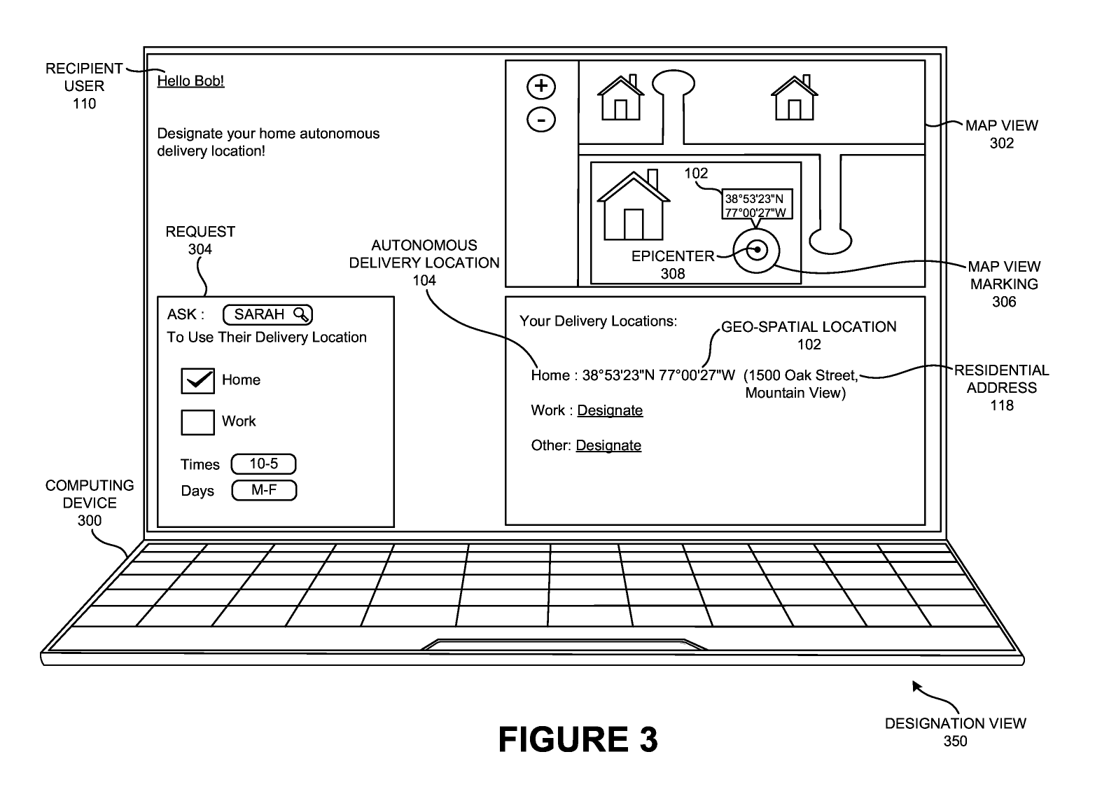

FIG. 3 is a designation view 350 of a recipient user designating an autonomous delivery location with a map view marking using a computing device, according to one embodiment. In particular, FIG. 3 shows a computing device 300, a map view 302, a request 304, a map view marking 306, and an epicenter 308. In one embodiment, the recipient user 110 may be able to use the computing device 300 (e.g., a desktop computer and/or a data processing system without location services (e.g., GPS)) to indicate that a geo-spatial location 102 is desired to be an autonomous delivery location 104 (e.g., a home autonomous delivery location and/or a work autonomous delivery location 104). The recipient user 110 may access (e.g., log into) the autonomous delivery network 150 (e.g., using Fatdoor.com, Nextdoor.com, and/or an application on the user device (e.g., the mobile device 108 and/or the computing device 300). The computing device 300 may display a map view 302 showing one or move view points of the residential and/or public address 402. The map view 302 may show a satellite map, a geometric map, a ground-level view, an aerial view, a three-dimensional view, and/or another type of map view 302.

The recipient user 110 may be able to select a point (e.g., a geo-spatial location 102) on the map view 302 to designate as the autonomous delivery location 104. The geo-spatial location 102 may be selected in and/or by the map view marking 306 created on the map view 302 by the recipient user 110. The recipient user 110 may be able to zoom in and/or out of the map view 302. The zoom in and/or out function may enable the user to select a more precise geo-spatial location 102 to set as the epicenter 308 and/or designate the autonomous delivery location 104. The map view marking 306 may designate the geo-spatial location 102 as the epicenter 308. The autonomous delivery location 104 may be an area (e.g., the radial vicinity 105) no more than five meters in radial diameter from the epicenter 308 (e.g., the geo-spatial location 102).

In one embodiment, the user may be able to “lock in” the map view marking 306 and/or communicate the designation data 106 from the computing device 300 and/or mobile device 108 to the landing server 100. The map view marking 306 may only be allowed to be placed in the tract boundary 120 of the address. The recipient user 110 may only be permitted to designate the autonomous delivery location 104 in their backyard and/or may need to assume responsibility of stolen items (e.g., items left in an unprotected autonomous delivery location 104 (e.g., in a front yard)). In one embodiment, recipient users 110 may be required to have a clear path to allow the autonomous vehicle 124 (e.g., a land-based autonomous vehicle 124) to traverse from a street, sidewalk, and/or its path to the autonomous delivery location 104.

The recipient user 110 may be able to send the request 304 to another user (e.g., the friend user 128B) of the autonomous delivery network 150 asking for permission for the recipient user 110 to use (e.g., rent and/or borrow) the autonomous delivery location 104 of the other user. The request 304 may enable the recipient user 110 to ask for permission to use the residential and/or the public autonomous delivery location of the other user and/or specify days of the week, specific dates, and/or times to use the at least one autonomous delivery location 104 of the other user. The request 304 may be for standing access within a specified window of time (e.g., a request 304 to use the other user's residential autonomous delivery location on any Monday-Friday from 2 pm-3 pm) and/or a request 304 to use the autonomous delivery location 104 of the other user for a particular delivery (e.g., on May 15, 2014 at 12:30 pm). In one embodiment, public addresses 402 (e.g., a user's work) may prohibit associated users (e.g., recipient users 110) to allow friend users 128B (e.g., other users) to use the public autonomous delivery location associated with the public address 402 and/or may enable recipient users 110 to share the public autonomous delivery location on certain days and/or times only.

FIG. 4 is a table view 450 illustrating data relationships between recipient users, friend users, and autonomous delivery locations, according to one embodiment. Particularly, FIG. 4 illustrates a public address 402, an approved friend user 404, and a friend user 128B location. The table of FIG. 4 may be a table of the database 115 of the landing server 100 (shown in FIG. 1). The table may mark and/or store the geo-spatial location 102 indicated by the designation data 106 as the autonomous delivery location 104 and/or associate the autonomous delivery location 104 with the recipient user 110. The table may associate the autonomous delivery location 104 and/or the recipient user 110 with the residential address 118 and/or the public address 402 (e.g., a work address and/or a public area (e.g., a park)) associated with the geo-spatial location 102 and/or the tract boundary 120 in which the geo-spatial location 102 is fully and/or partially located.

In one embodiment, the table may store and/or show the relationships between the recipient user 110, the autonomous delivery location(s) 104 of the recipient user 110, friend users 128B, and/or the friend user delivery locations 406 (e.g., the autonomous delivery location(s) 104 of friend users 128B to which the recipient user 110 has been granted access). The approved friend user 404 may be a user of the autonomous delivery network 150 with whom the recipient user 110 has indicated a relationship and/or to whom the recipient user 110 has granted access to at least one of the autonomous delivery locations 104 of the recipient user 110. For example, Sarah Johnson is an approved friend user 404 of Bob Jones. Sarah Johnson has been granted permission to use the residential autonomous delivery location (e.g., the autonomous delivery location 104) and/or the public autonomous delivery location (e.g., the autonomous delivery location 104) of Bob Jones from 10 am to 5 pm Monday to Friday. Bob Jones may be able to alter the arrangement (e.g., restrict and/or expand Sarah's access) as he pleases. In addition, Bob may be able to approve (e.g., grant access to) additional users (e.g., friend users 128B). In another example, Mike Smith is shown to be the approved friend user 404 of Jenna Doe and has been given permission to user (e.g., borrow and/or rent) Jenna Doe's residential autonomous delivery location (e.g., “Home” autonomous delivery location 104) from 9 am to 6 pm on Saturdays and Sundays.

The friend user delivery location 406 may be the autonomous delivery location 104 associated with the friend user 128B that has granted access to the recipient user 110. For example, Bob Jones has been granted permission to use Sarah Johnson's “Home” autonomous delivery location from 10 am-5 pm Monday-Friday and/or Mike Smith's “Home” autonomous delivery location from 9 am-6 pm on Saturdays and Sundays. Jenna Does is shown to have no approved friend user 404 delivery location (e.g., she has not been granted access to the autonomous delivery location 104 of another user of the autonomous delivery network 150).

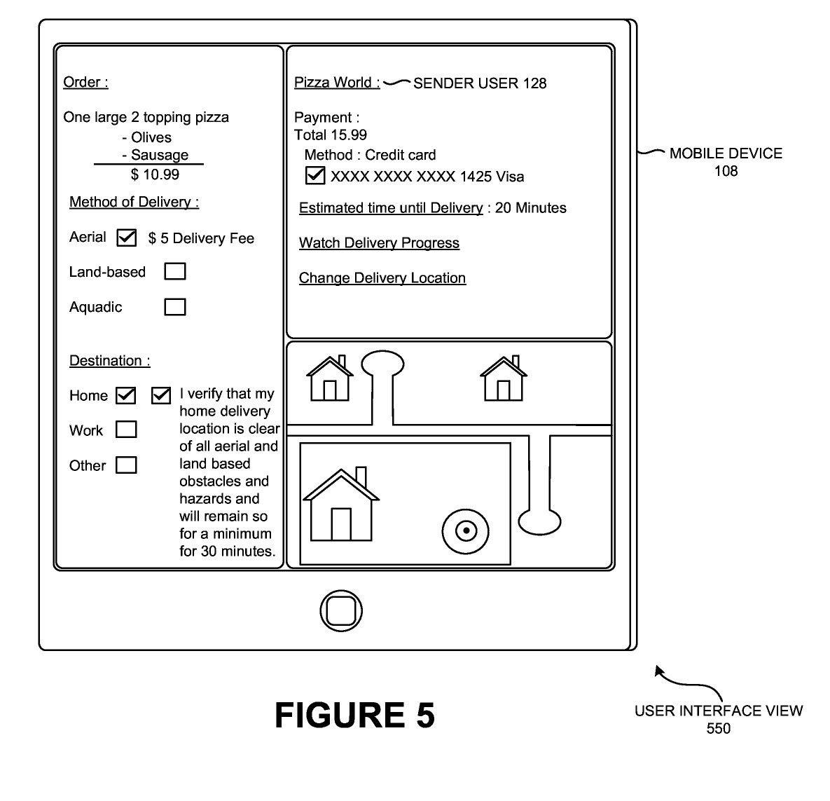

FIG. 5 is a user interface view 550 of the mobile device of FIG. 1 requesting a payload be delivered to the residential autonomous delivery location of the recipient user, according to one embodiment. In one embodiment, the recipient user 110 may log onto the autonomous delivery network 150 and/or the page (e.g., web page and/or profile) of the sending user 128 from whom a payload 126 is desired (e.g., using a web browser (e.g., Google®) and/or an application on the mobile device 108 (e.g., a Fatdoor app). The recipient user 110 may request 304 the payload 126 be delivered by placing an order through the mobile device 108. The recipient user 110 may be able to select a delivery means (e.g., aerial, land-based, and/or aquatic) associated with an autonomous vehicle 124 (e.g., an aerial vehicle, a land-based vehicle, and/or an aquatic vehicle). In one embodiment, the delivery may require an additional fee (e.g., a delivery fee) be paid (e.g., to the autonomous delivery network 150).

The recipient user 110 may be required to give (e.g., input and/or upload) their credit card information to the autonomous delivery network 150 and/or the sending user 128 before the request 304 for the payload 126 is processed and/or executed. The recipient user 110 may be responsible for any damage to the autonomous vehicle 124, the payload 126, and/or anything in and/or around the autonomous delivery location 104. Any such damage may be automatically compensated using the credit card information of the recipient user 110.

The recipient user 110 may be able to indicate (e.g., select) which autonomous delivery location 104 the recipient user 110 desired the payload 126 be delivered to. In one embodiment, the recipient user 110 may be able to designate multiple autonomous delivery locations 104 for their residential address 118 and/or public address 402. Once the user has indicated the desired autonomous delivery location 104, the recipient user 110 may be prompted and/or required to read and/or accept conditions of use (e.g., verify that the autonomous delivery location 104 is accessible, safe, and/or clear for delivery). In one embodiment, the conditions of use may include assumption of responsibility by the recipient user 110 for the safety of any living thing and/or piece of property within a threshold area around the autonomous delivery location 104 from the time the payload 126 is requested until the delivery is completed. The area may be the radial area and/or a cylindrical area a certain distance above and/or below the radial area. The recipient user 110 may be required to take responsibility for damage caused in the cylindrical area including the autonomous delivery location 104. Damage that the recipient user 110 is responsible for may be automatically covered using the credit card information of the recipient user 110.

The recipient user 110 may be provided with an estimated time of delivery and/or an estimated time until delivery. The recipient user 110 may be able to track the payload delivery using the mobile device 108. The recipient user 110 may be able to watch a video feed captured by the autonomous vehicle 124 while making the delivery, view pictures captured by the autonomous vehicle 124, and/or may receive updates (e.g., at regular time and/or distance intervals) from the autonomous vehicle 124 and/or landing server 100. The mobile device 108 may display a map showing the autonomous delivery location 104 (e.g., when the recipient user 110 is indicating which autonomous delivery location 104 the delivery should be made to) and/or the progress of the autonomous vehicle 124. While FIG. 5 shows the mobile device 108, the abovementioned could be achieved using the computing device 300.

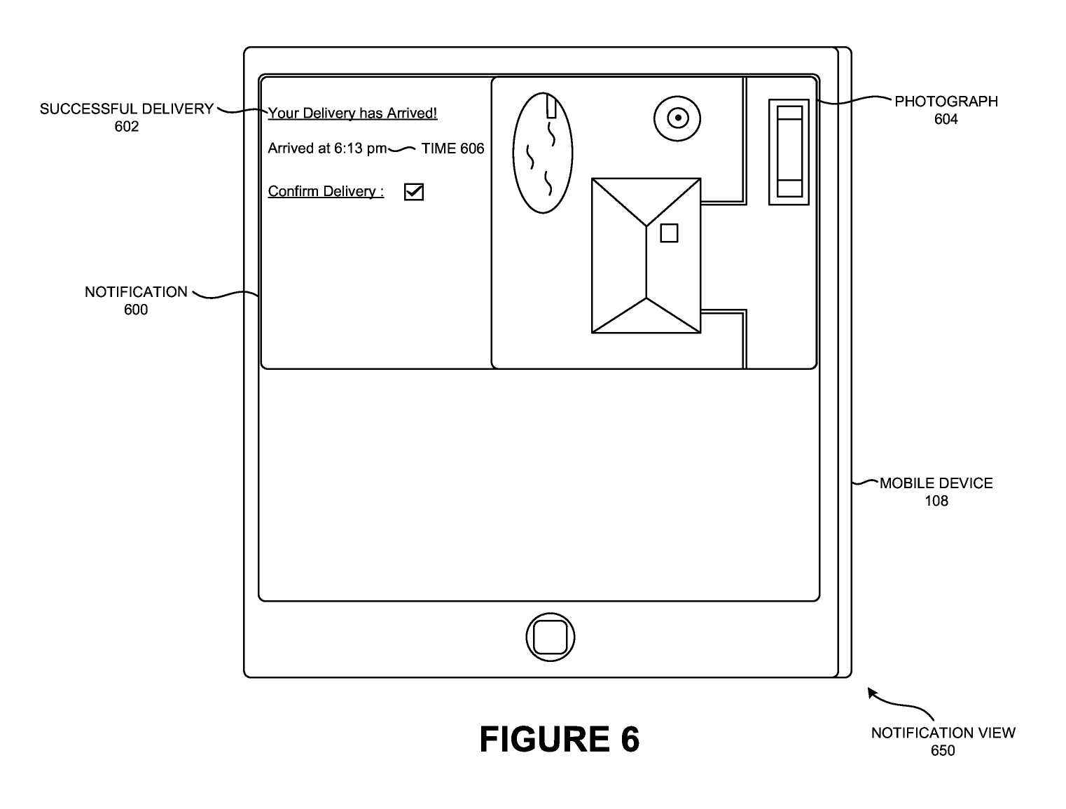

FIG. 6 is a notification view 650 of the mobile device of FIG. 5 receiving a notification including a photograph as proof of a successful delivery, according to one embodiment. FIG. 6 illustrates a notification 600, a successful delivery 602, a photograph 604, and a time 606. The autonomous vehicle 124 may be instructed to take a photograph 604 to confirm the successful delivery 602. The photograph 604 may be of an aerial view over the autonomous delivery location 104, a photo taken from the ground once the autonomous vehicle 124 has landed and/or a photograph 604 of the payload 126 at the autonomous delivery location 104 (e.g., an aerial view of the payload 126 left at the autonomous delivery location 104). The autonomous vehicle 124 and/or landing server 100 may store a time stamp and/or geo-spatial location 102 associated with the photograph 604. The autonomous vehicle 124 and/or the landing server 100 may communicate the photograph 604 and/or notification 600 the recipient user 110 (e.g., through a push notification 600 on the mobile device 108 and/or a message (e.g., through the autonomous delivery network 150) on the computing device 300).

The notification 600 and/or photograph 604 may include a time 606 at which the delivery was made (e.g., a time stamp). The notification 600 may request 304 and/or require the recipient user 110 confirm (e.g., by selecting a confirmation function) the delivery using the mobile device 108 and/or computing device 300.

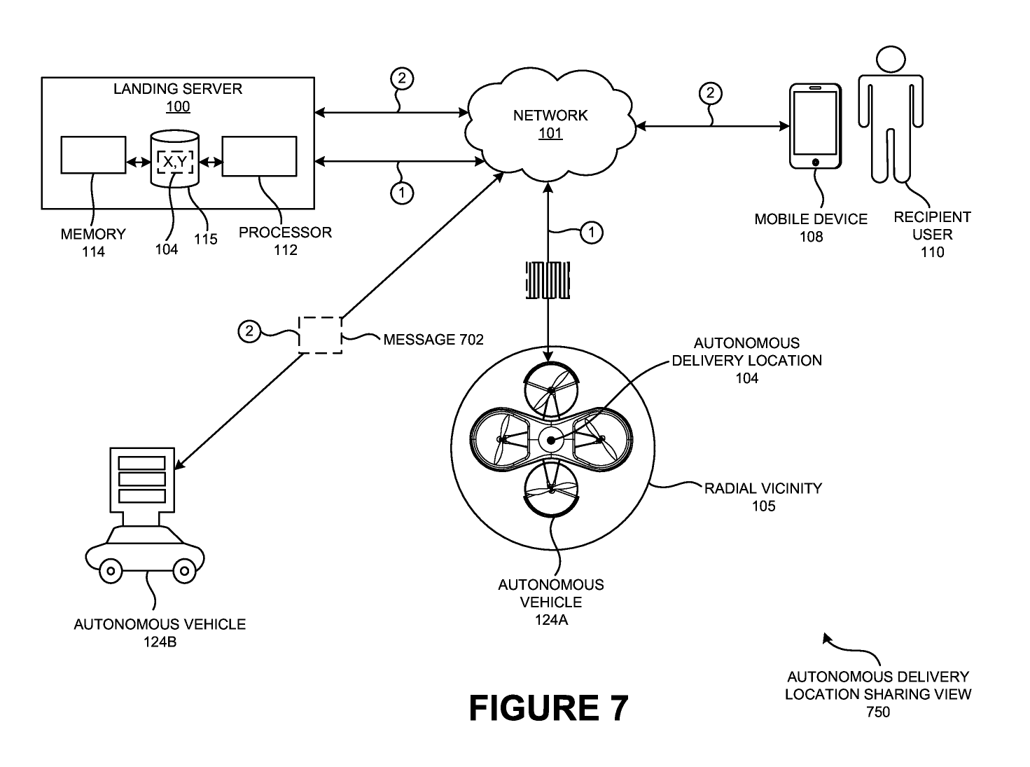

FIG. 7 is an autonomous delivery location sharing view 750 of a message being sent to an autonomous vehicle indicating that the autonomous delivery location is occupied, according to one embodiment. The landing server 100 may determine if and/or when the autonomous delivery location 104 is and/or will be free from obstruction by an autonomous vehicle 124A of the autonomous delivery network 150 before directing another autonomous vehicle 124B to the autonomous delivery location 104. In one embodiment the landing server 100 may use navigation data 122 and/or requests 304 (e.g., new and/or pending requests) for payload delivery to anticipate if and/or when a particular autonomous delivery location 104 will be occupied by an autonomous vehicle 124A of the autonomous vehicle 124 network 101.

In circle ‘1,’ the autonomous vehicle 124A communicates its current geospatial location to the landing server 100 through the network 101. In one embodiment, the landing server 100 may track the locations of all autonomous vehicles 124 in the autonomous delivery network 150 (e.g., using the GPS network). The autonomous vehicle 124A may be required to remain at the autonomous delivery location 104 until the recipient user 110 removes the payload 126 and/or confirms delivery. The autonomous vehicle 124A may communicate the status of the delivery and/or readiness to vacate the autonomous delivery location 104 when the payload 126 has been removed and/or when the delivery has been confirmed.

In circle ‘2,’ upon determining that the autonomous delivery location 104 is occupied by an autonomous vehicle 124A, the landing server 100 communicates a message 702 through the network 101 to the autonomous vehicle 124B instructing the autonomous vehicle 124B to wait and/or that the autonomous delivery location 104 is occupied. The message 702 may be included in the navigation data 122 and/or may be factored into the navigation data 122 so that the autonomous vehicle 124B automatically waits and/or arrives when the autonomous delivery location 104 is not occupied. In addition, circle ‘2’ shows the landing server 100 notifying the recipient user 110, through the mobile device 108. The notification 600 may inform the recipient user 110 that the autonomous delivery location 104 is obstructed and/or that a second deliver (e.g., the payload delivery for autonomous vehicle 124B) is delayed due to an overlap in use of the autonomous delivery location 104 (e.g., a friend user delivery at the autonomous delivery location 104 of the recipient user 110 has caused a delivery requested by the recipient user 110 to be delayed).

In one embodiment, the abovementioned messaging and notifying may be triggered by a sensing (e.g., by at least one sensor of the autonomous vehicle 124A) that the autonomous delivery location 104 is obstructed by an object (e.g., a person and/or a fallen branch). The landing server 100 may determine that the autonomous delivery location 104 is not viable (e.g., blocked and/or unsafe) using data communicated by the autonomous vehicle 124A. The landing server 100 may communicate the message 702 to the autonomous vehicle 124B instructing the autonomous vehicle 124B to wait. The message 702 may be included in the navigation data 122 and/or may be factored into the navigation data 122 so that the autonomous vehicle 124B automatically waits and/or arrives when the autonomous delivery location 104 is free from the sensed obstruction. The landing server 100 may notify the recipient user(s) 110 associated with the autonomous delivery location 104 (e.g., the recipient user 110 that designated the autonomous delivery location 104 and/or the friend user 128B with access to the autonomous delivery location 104) of the obstruction. The recipient user 110 may be requested to clear the autonomous delivery location 104 of the obstruction and/or ensure that the autonomous delivery location 104 remains safe for delivery. The recipient user 110 may be able to indicate to the landing server 100 that the problem has been resolved and/or the landing server 100 may be able to communicate another message and/or navigation data 122 to the autonomous vehicle 124A and/or autonomous vehicle 124B.

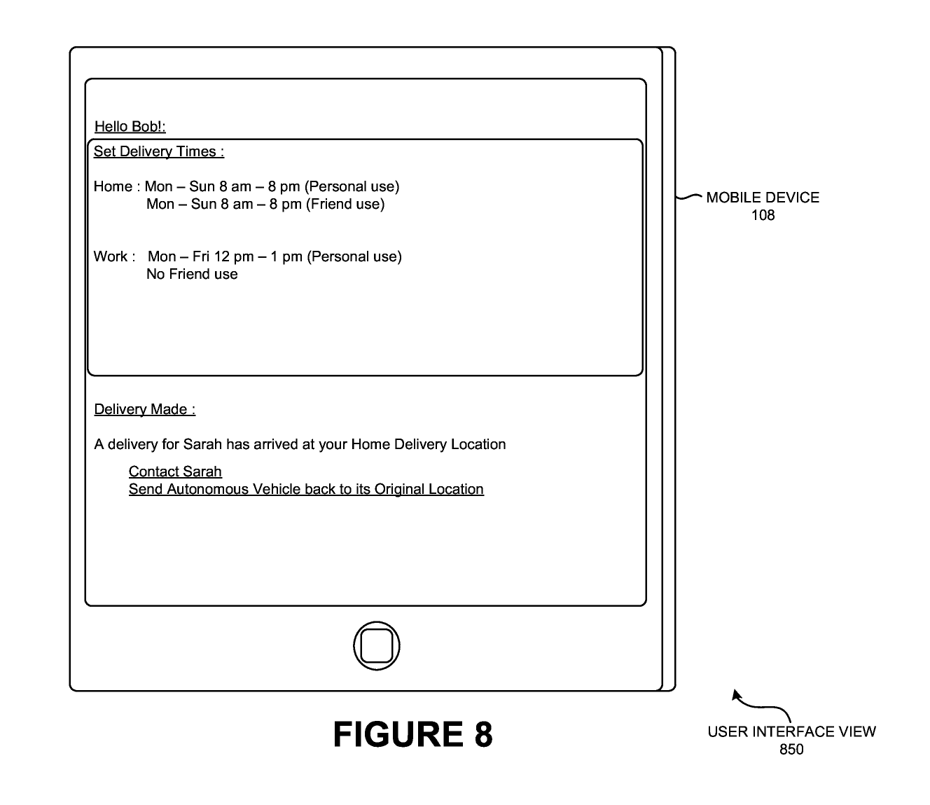

FIG. 8 is a user interface view 850 of the mobile device of the recipient user of FIG. 1 selecting when the autonomous delivery location is online and offline, according to one embodiment. The recipient user 110 may be able to choose when the residential autonomous delivery location and/or public autonomous delivery location of the recipient user 110 is online or offline for personal use and/or friend use (e.g., when friend users 128B have access to the autonomous delivery locations 104). The recipient user 110 may be able to set online and/or offline times for specific friend users. Autonomous vehicles may be constrained to only make deliveries to the autonomous delivery location 104 when the autonomous delivery location 104 is online. The user (e.g., the recipient user 110 and/or friend user 128B) may not be able to request 304 payload deliveries when the autonomous delivery location 104 is offline. In one embodiment, requests 304 for payload deliveries that are placed when the autonomous delivery location 104 is offline or cannot be delivered before the autonomous delivery location 104 goes offline may be stored and/or carried out at a later time (e.g., the next day once the autonomous delivery location 104 comes back online).

The recipient user 110 may receive a notification 600 informing them that a friend user's 128B delivery has been made at the autonomous delivery location 104 of the recipient user 110. The recipient user 110 may be able to contact the friend user 128B (e.g., through the profile of the user on the requests 304 autonomous delivery network 150 and/or through the use of a phone number of the friend user 128B and/or an email address of the friend user 128B). The friend user 128B may receive a message (e.g., a similar message to the message received by the recipient user 110) and/or may be able to automatically contact the recipient user 110 (e.g., to request 304 the recipient user 110 secure the payload 126 and/or allow the friend user 128B to come on to the recipient user's 110 property to retrieve the payload 126. The recipient user 110 and/or the friend user 128B may be able to send the autonomous vehicle 124 away (e.g., to a predetermined location, to an originating location, and/or to the location of the sending user 128) using the mobile device 108 and/or the computing device 300.

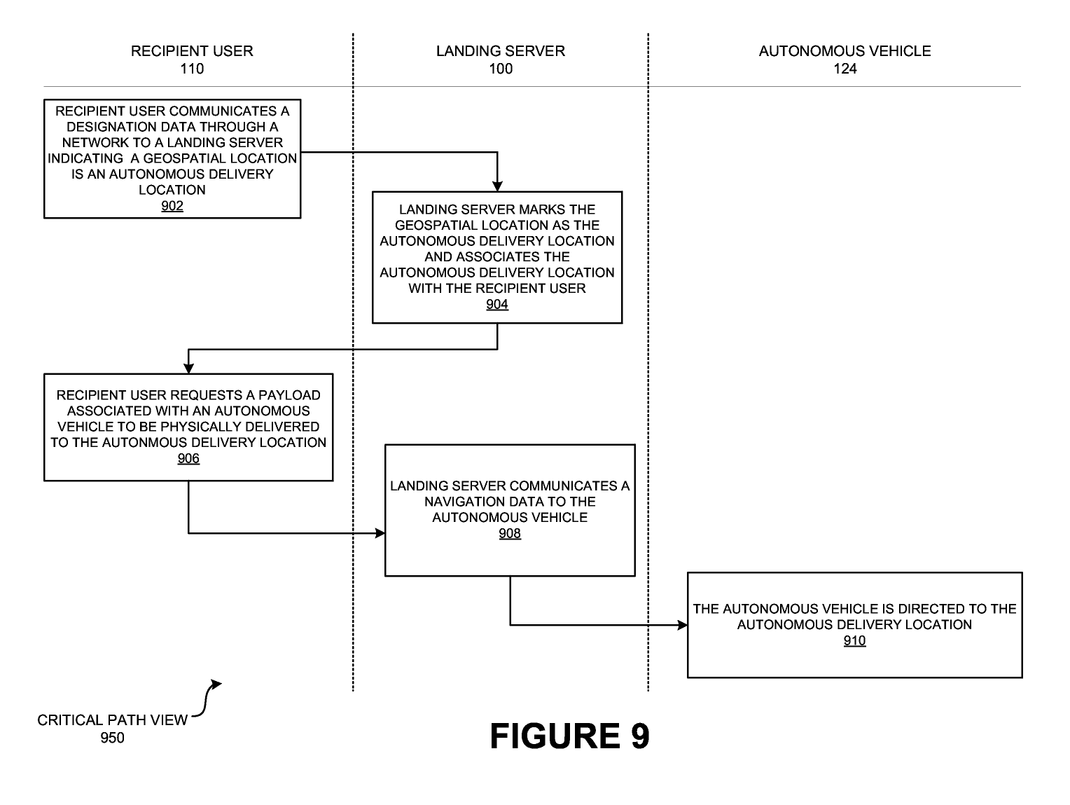

FIG. 9 is a critical path view 950 illustrating a flow based on time in which critical operations in designating the autonomous delivery location of FIG. 1 and delivering a payload are established, according to one embodiment. In operation 902, a recipient user 110 communicates a designation data 106 through a network 101 to a landing server 100 indicating that a geo-spatial location 102 is an autonomous delivery location 104. The landing server 100 marks the geo-spatial location 102 as the autonomous delivery location 104 and associates the autonomous delivery location 104 with the recipient user 110 in operation 904.

The recipient user 110 then requests 304 a payload 126 associated with an autonomous vehicle 124 to be delivered to the autonomous delivery location 104 in operation 906. In operation 908, the landing server 100 communicates a navigation data 122 to the autonomous vehicle 124. Finally, the autonomous vehicle 124 is directed, with the payload 126, to the autonomous delivery location 104 by the navigation data 122 communicated by the landing server 100 in operation 910.

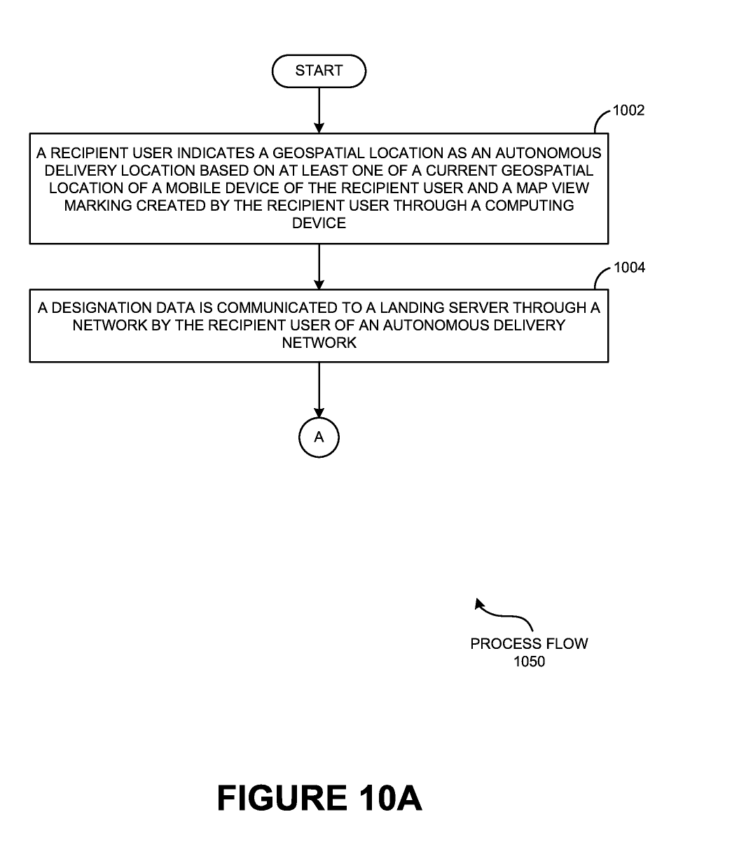

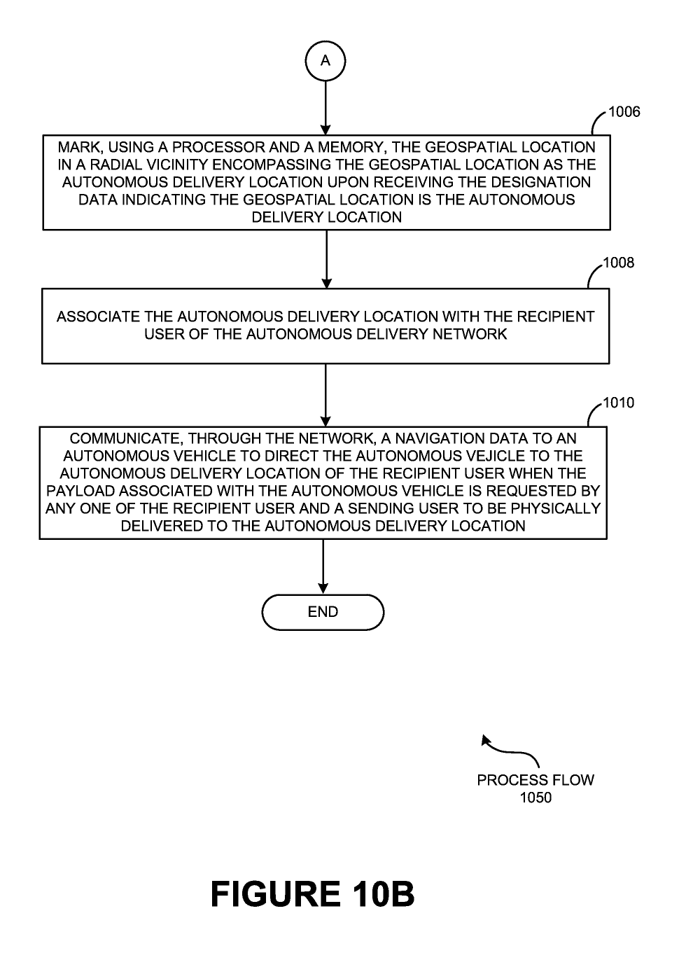

FIG. 10A is a process flow 1050 of designating an autonomous delivery location of FIG. 1 and delivering a payload to the autonomous delivery location of FIG. 1, according to one embodiment. Particularly, in operation 1002 of FIG. 10A, a recipient user 110 may indicate a geospatial location as an autonomous delivery location 104 based on at least one of a current geospatial location of a mobile device 108 of the recipient user 110 and a map view marking 306 created by the recipient user 110 through a computing device 300. The designation data 106 may be communicated to a landing server 100 through a network 101 by the recipient user 110 of an autonomous delivery network 150 in operation 1004.

FIG. 10B is a continuation of the process flow 1050 of FIG. 10A showing additional processes, according to one embodiment. In FIG. 10B, operation 1006 the landing server 100 may mark, using a processor and a memory, the geospatial location in a radial vicinity 105 encompassing the geospatial location as the autonomous delivery location 104 upon receiving a designation data 106 indicating the geospatial location is the autonomous delivery location 104. Operation 1008 may associate the autonomous delivery location 104 with the recipient user 110 of the autonomous delivery network 150. Finally, operation 1010 may communicate, through the network 101, a navigation data 122 to an autonomous vehicle 124 to direct the autonomous vehicle 124 to the autonomous delivery location 104 of the recipient user 110 when a payload 126 associated with the autonomous vehicle 124 is requested by any one of the recipient user 110 and a sending user 128 to be physically delivered to the autonomous delivery location 104.

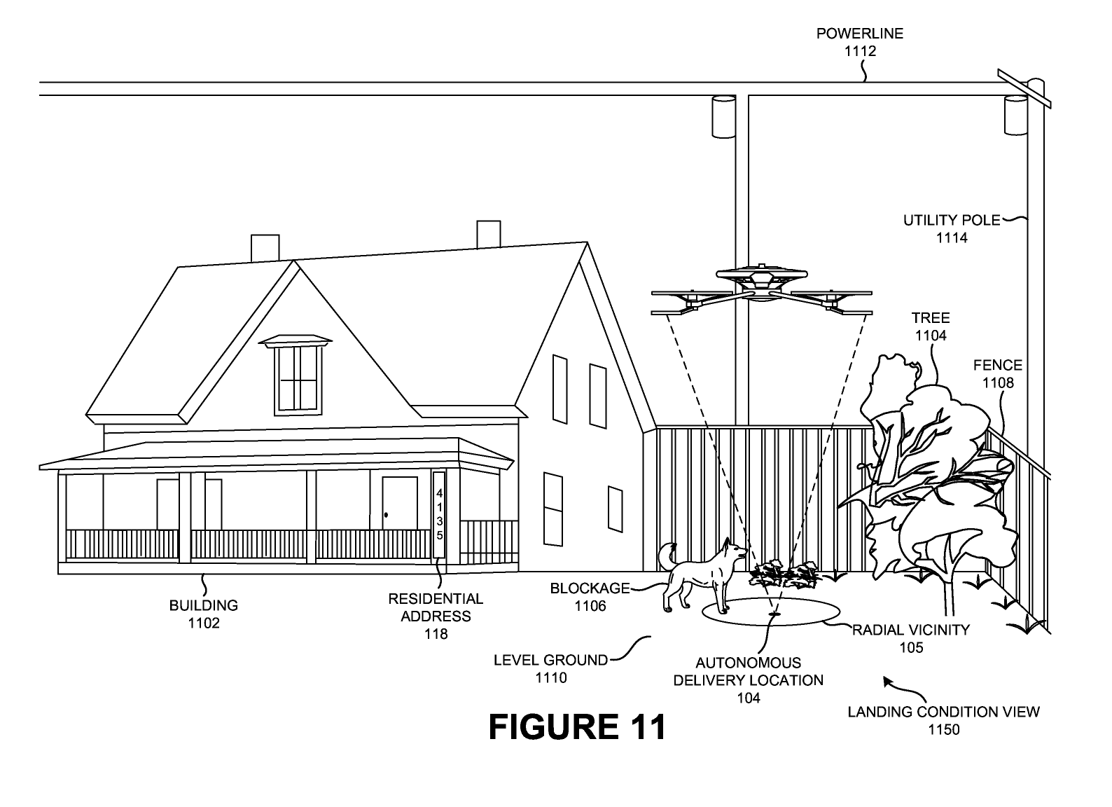

FIG. 11 is a landing condition view 1150 of the autonomous vehicle of FIG. 1 attempting to land at an obstructed autonomous delivery location, according to one embodiment. FIG. 11 shows a building 1102, a tree 1104, a blockage 1106, a fence 1108, a level ground 1110, a powerline 1112, and a utility pole 1114. In one embodiment, the recipient user 110 may be required to verify that the autonomous delivery location 104 is free from any land-based, aquatic, and/or aerial obstructions. This may include obstructions in the radial vicinity 105, in a cylindrical area extending above and/or below the autonomous delivery location 104, and/or obstructions in an area that the autonomous vehicle 124 is required to traverse in order to reach the autonomous delivery location 104.

The autonomous delivery network 150 may require the recipient user 110 to assume responsibility of their autonomous delivery location 104 and/or anything including the autonomous vehicle 124 and/or the payload 126 that enters a specified area around the autonomous delivery location 104 (e.g., an associated airspace, the threshold area, the radial vicinity 105, a cylindrical area extending above and/or below the autonomous delivery location 104, and/or an area (e.g., air space, water ways, and/or land areas) that the autonomous vehicle 124 is required to traverse in order to reach the autonomous delivery location 104). In one embodiment, the recipient user 110 may be responsible for friend user 128B deliveries made to the autonomous delivery location 104 of the recipient user 110 and/or may be required to ensure the autonomous delivery location 104 of the recipient user 110 is on level ground 1110 and/or free from obstructions in order for deliveries requested by friend users 128B to be successfully completed.

The autonomous vehicle 124 may detect (e.g., using one or more sensors of the autonomous vehicle 124) an obstruction of the autonomous delivery location 104, the radial vicinity 105, and/or the specified area around the autonomous delivery location 104. The obstruction may be aquatic (e.g., weeds, a dock, a log, a swimmer, and/or a vehicle), land-based (e.g., a bush, the fence 1108, the building 1102, and/or a blockage 1106 (e.g., an animal, a person, and/or an object)) and/or aerial (e.g., the tree 1104, the utility pole 1114, the powerline 1112, and/or an overhang). The autonomous vehicle 124 may communicate a message (e.g., the message of FIG. 7) to the recipient user 110 and/or the landing server 100. The recipient user 110 may be required to clear the autonomous delivery location 104, the radial vicinity 105, and/or the specified area around the autonomous delivery location 104 of the sensed obtrusions. In one embodiment, the autonomous vehicle 124 may automatically return to the sending user 128, a designated home location, and/or an originating location from where the autonomous vehicle 124 came upon detecting an unsafe and/or obstructed autonomous delivery location 104. The landing server 100 may instruct the autonomous vehicle 124 to cancel and/or postpone the delivery of the payload 126 upon receiving the message indicating an unfit autonomous delivery location 104. In one embodiment, the recipient user 110 may not be refunded the delivery fee if the autonomous delivery location 104 (e.g., the geo-spatial location 102 and/or the radial vicinity 105) and/or the specified area around the autonomous delivery location 104 is not free from obstruction (e.g., obstructions not including other autonomous vehicles 124 of the autonomous delivery network 150) and/or on level ground 1110. In one embodiment, the landing server 100 may determine that the geo-spatial location 102 is on level ground 1110 before marking the geo-spatial location 102 as the autonomous delivery location 104.

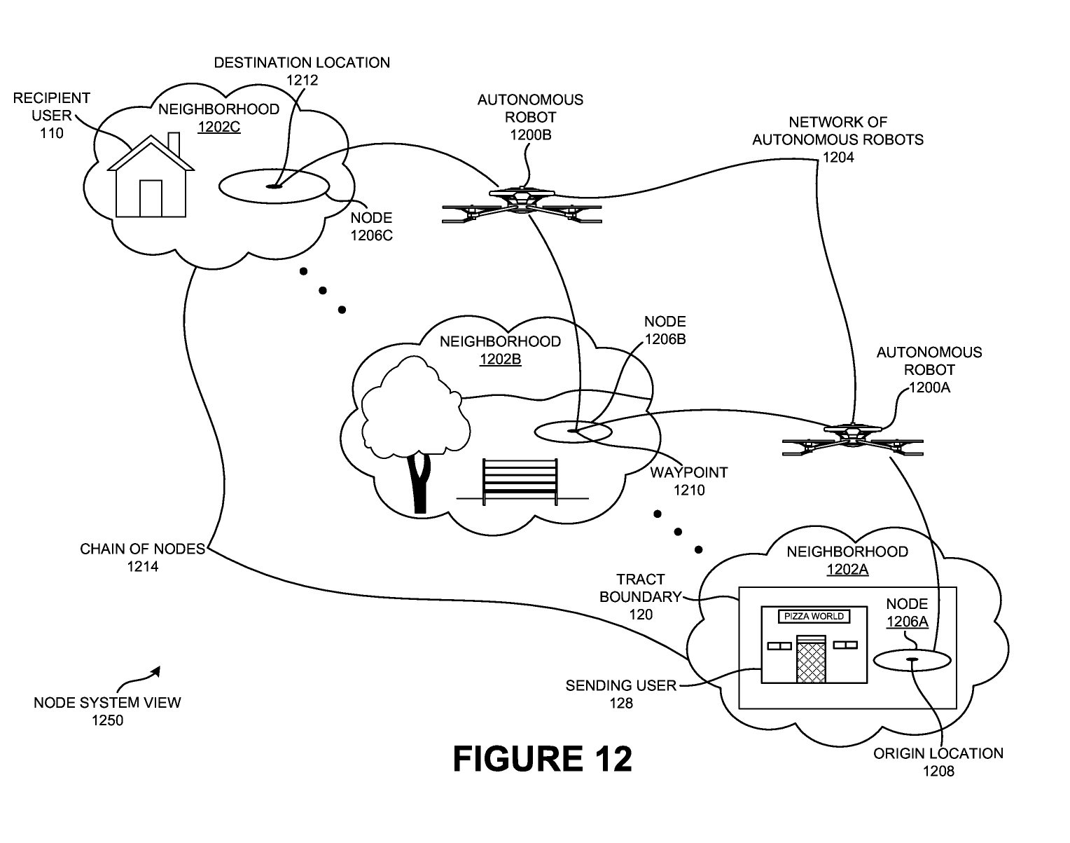

FIG. 12 is a node system view 1250 of a network of autonomous robots working in concert to transport a payload across a chain of nodes serving as waypoints between an original location and a destination location, according to one embodiment. In particular, FIG. 12 shows an autonomous robot 1200A, and autonomous robot 1200B, a neighborhood 1202A, a neighborhood 1202B, a neighborhood 1202C, a network of autonomous robots 1204, a node 1206A, a node 1206B, a node 1206C, an origin location 1208, a waypoint 1210, a destination location 1212, and a chain of nodes 1214. In one embodiment, the recipient user 110 may request 304 a pay load from a sending user 128 that is a greater distance away from the autonomous delivery location 104 of the recipient user 110 than an autonomous robot (e.g., the autonomous vehicle 124) may be able to travel. In one embodiment, the path from the sending user 128 to the recipient user 110 may require multiple modes of transportation (e.g., air, sea, and/or land). The network of autonomous robots 1204 may work in concert to transport the payload 126 across the chain of nodes 1214 in order to deliver the payload 126 at the destination location 1212 (e.g., the autonomous delivery location 104 of the recipient user 110 that is out of range for a single autonomous vehicle 124).

In one embodiment, the recipient user 110 may live in and/or request 304 a payload 126 be delivered to an autonomous delivery location 104 in a neighborhood 1202C. The sending user 128 from whom the payload 126 was requested may be located in a neighborhood 1202A. The sending user 128 and recipient user 110 may be in the same a neighborhood but the distance between the origin location 1208 and the destination location 1212 may be too great for a single autonomous robot to travel. In order to complete the delivery, the autonomous delivery network 150 may employ the network of autonomous robots 1204 to shuttle the payload 126 across multiple nodes in the chain of nodes 1214 to the destination location 1212 (e.g., the autonomous delivery location 104 of the recipient user 110). The network of autonomous robots 1204 may work in concert to lift a payload 126 that is too large and/or heavy to be transported by a single autonomous robot.

In the example embodiment of FIG. 12, a payload 126 of the sending user 128 in a neighborhood 1202A may be requested by the recipient user 110 in a neighborhood 1202C. The autonomous robot 1200A may transport the payload 126 from the node 1206A (e.g., the origin location 1208) in the tract boundary 120 of the sending user 128 to the waypoint 1210 (e.g., node 1206B) in the neighborhood 1202B. The waypoint 1210 may be an autonomous delivery location 104 of the recipient user 110 and/or sending user 128 and/or an autonomous delivery location 104 that recipient user 110 and/or the sending user 128 has access to (e.g., has been granted permission by a friend user 128B and/or is a public autonomous delivery location for use by anybody as long as the public autonomous delivery location is online).

The waypoint 1210 may be an autonomous delivery location 104 that the recipient user 110 and/or sending user 128 has access to and/or is the closest autonomous delivery location 104 to the edge of the transportation range of the autonomous robot 1200A (e.g., the farthest autonomous delivery location 104 the autonomous robot 1200A may reach along a route to the destination location 1212 (e.g., the node 1206C) and/or still be able to return to a desired location). Once the autonomous robot 1200A has delivered the package to the node 1206B, the autonomous robot 1200B may continue the payload 126 along its route to the destination location 1212. The autonomous robot 1200B may secure (e.g., pick up and/or be physically associated with) the payload 126 brought to the waypoint 1210 by the autonomous robot 1200A and/or may transport the payload 126 to the destination location 1212 in the neighborhood 1202C and/or may transport the payload 126 along the chain of nodes 1214, delivering the payload 126 to another waypoint 1210 along the route from the origin location 1208 to the destination location 1212.

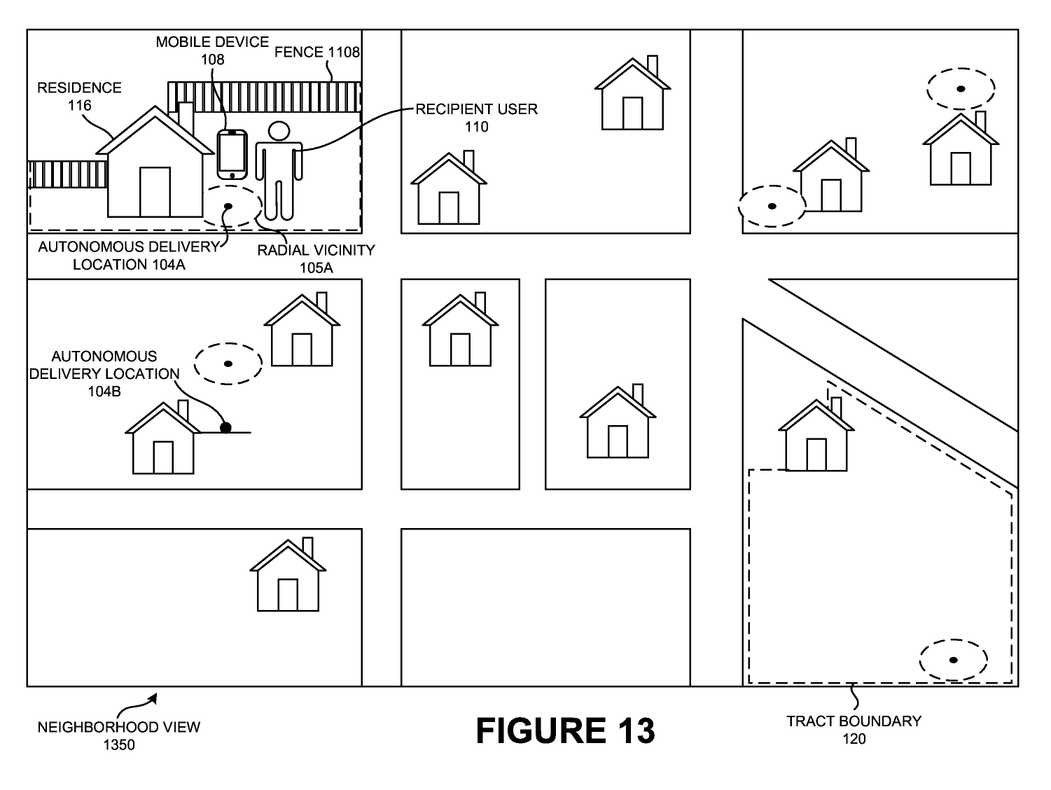

FIG. 13 is a neighborhood view 1350 of an autonomous delivery location being designated, using a mobile device, in a neighborhood having other autonomous delivery locations, according to one embodiment. The recipient user 110 may indicate that the current geospatial location of the mobile device 108 of the recipient user 110 is to be marked by the landing server 100 as the autonomous delivery location 104. The autonomous delivery location 104A and/or the radial vicinity 105A may be located completely in the tract boundary 120 of the residence 116 associated with the recipient user 110. The tract boundary 120 may be a property boundary associated with the residential address 118 and/or residence 116 associated with the recipient user 110 and/or the geo-spatial location 102 (e.g., the current geospatial location of the mobile device 108). The fence 1108 may extend along and/or represent the tract boundary 120.

In one embodiment, the landing server 100 may verify that the recipient user 110 lives at the residence 116 (e.g., the claimable residential address 118) associated with the geo-spatial location 102. The recipient user 110 may need to provide the autonomous delivery network 150 with proof (e.g., a contract, a deed, a lease, a utility bill, and/or a valid driver's license) that the recipient user 110 in fact lives at the residential address 118 and/or is associated with (e.g., works at) the public address 402 before the geo-spatial location 102 is marked as the autonomous delivery location 104 and/or deliveries may be made to the autonomous delivery location 104. In one embodiment, the landing server 100 may verify that the geo-spatial location 102 and/or the radial vicinity 105 associated with the geo-spatial location 102 is/will be encompassed by the tract boundary 120 of the residence 116 and/or public address 402 before marking the geo-spatial location 102 as the autonomous delivery location 104.

The autonomous delivery location 104B may be located on a platform mounted by the recipient user 110 (e.g., a platform attached to an elevated part of the residence 116 (e.g., the roof)). The autonomous delivery location 104B may be designated for aerial vehicles only. The autonomous delivery location 104 (e.g., the autonomous delivery location 104B) may be located on a roof (e.g., a roof with a level ground 1110 and/or free from obstructions). The recipient user 110 associated with the autonomous delivery location 104B may be able to designate any number of additional autonomous delivery locations 104 as long as the autonomous delivery locations 104 and/or the radial vicinities meet certain criteria (e.g., are encompassed in an appropriate tract boundary 120, are on level ground 1110, are free from hazards and/or obstructions, do not overlap and/or interfere with the location, safety, and/or accessibility of other autonomous delivery sites and/or radial vicinities). In the example embodiment of FIG. 13, the recipient user 110 (not shown) associated with the autonomous delivery location 104B may designate additional autonomous delivery locations 104 on a ground associated with the residence 116 of the recipient user 110 associated with the autonomous delivery location 104B for deliveries made by land-based vehicles.

Disclosed are a method and system of landing site designation in an autonomous delivery network 150, according to one embodiment. In one embodiment, a method of a landing server 100 includes marking, using a processor and a memory, a geo-spatial location 102 in a radial vicinity 105 encompassing the geo-spatial location 102 as an autonomous delivery location 104 upon receiving a designation data 106 indicating the geo-spatial location 102 is the autonomous delivery location 104. The designation data 106 is communicated to the landing server 100 through a network 101 by a recipient user 110 of an autonomous delivery network 150. The recipient user 110 indicates the geo-spatial location 102 as the autonomous delivery location 104 based on at least one of a current geospatial location of a mobile device 108 of the recipient user 110 and a map view marking 306 created by the recipient user 110 through a computing device 300. The autonomous delivery location 104 is associated with the recipient user 110 of the autonomous delivery network 150. A navigation data 122 is communicated through the network 101 to an autonomous vehicle 124 to direct the autonomous vehicle 124 to the autonomous delivery location 104 of the recipient user 110 when a payload 126 associated with the autonomous vehicle 124 is requested by any one of the recipient user 110 and a sending user 128 to be physically delivered to the autonomous delivery location 104.

It may be determined that the recipient user 110 lives at a residence 116 associated with a claimable residential address 118 of the autonomous delivery network 150 formed through a social community algorithm of a privacy server using a processor and a memory. The autonomous delivery location 104 may be verified to be encompassed by a tract boundary 120 of the residence 116 prior to the landing server 100 accepting the geo-spatial location 102 as the autonomous delivery location 104. It may be determined that the recipient user 110 is associated with a public address 402 associated with a claimable public address 402 of the autonomous delivery network 150 formed through the social community algorithm of the privacy server using the processor and the memory. The autonomous delivery location 104 may be verified to be encompassed by the tract boundary 120 of the public address 402 prior to accepting the geo-spatial location 102 as the autonomous delivery location 104. The autonomous delivery network 150 may automatically notify the recipient user 110 at a time when the payload 126 is delivered to a residential address 118 and/or the public address 402. The public address 402 may be a work address, a park address, a public forum address, and/or a community center address.

The current geospatial location of the mobile device 108 may be determined. The current geospatial location of the mobile device 108 may be associated with the autonomous delivery location 104 in the radial vicinity 105 encompassing the current geospatial location of the mobile device 108 when the recipient user 110 of the mobile device 108 requests 304 the current geospatial location of their mobile device 108 as the autonomous delivery location 104.

The autonomous delivery location 104 may not be more than five meters in radial diameter from an epicenter 308 associated with the current geospatial location. The autonomous delivery location 104 may be associated with the recipient user 110 of the autonomous delivery network 150. The autonomous vehicle 124 may be directed to the autonomous delivery location 104 when the sending user 128 places the payload 126 in the autonomous vehicle 124 in route to the recipient user 110 through the autonomous delivery network 150. The sending user 128 may be a merchant 128C, a neighbor 128A, and/or a friend user 128B.

The recipient user 110 may be permitted to grant a friend user 128B of the recipient user 110 in the autonomous delivery network 150 permission to use the autonomous delivery location 104 of the recipient user 110. The recipient user 110 and/or the friend user 128B may be notified when another payload 126 requested by the friend user 128B from the sending user 128 is delivered to the autonomous delivery location 104 based on a request 304 of the friend user 128B to deliver the another payload to the autonomous delivery location 104. It may be automatically determined that the autonomous delivery location 104 is currently being occupied by another autonomous vehicle and/or otherwise obstructed. A message may be sent to the autonomous vehicle 124 to wait until the autonomous delivery location 104 is freed from obstruction. The recipient user 110 may be optionally notified when the autonomous delivery location 104 is obstructed.

The recipient user 110 may be permitted to select when the autonomous delivery location 104 is online and/or offline. The autonomous vehicle 124 may be instructed to deliver the payload 126 only when the autonomous delivery location 104 is online. The recipient user 110 may be requested to verify that the autonomous delivery location 104 is on a level ground 1110 and/or free from any land obstructions including a building 1102, a tree 1104, a blockage 1106, a fence 1108, and/or any land-based hazardous conditions. The recipient user 110 may be requested to verify that an associated airspace in which the autonomous vehicle 124 traverses above the autonomous delivery location 104 is free from any aerial obstructions including a power line, a utility pole 1114, a telephone line, a utility line, and/or any other aerial hazard condition.

It may be automatically requested that the autonomous vehicle 124 take a photograph 604 to confirm a successful delivery 602 of the payload 126 at the autonomous delivery location 104. The photograph 604 may be communicated to the recipient user 110 when the successful delivery 602 of the payload 126 is made to provide proof of delivery. The mobile device 108 may be a mobile phone, a landing beacon device, and/or a landing pod. The autonomous vehicle 124 may be a rover vehicle, an autonomous robot, an autonomous bicycle, a quadcopter, an octocopter, a multirotor aircraft, and/or a fixed wing aircraft.

The autonomous delivery location 104 may be a node in a chain of nodes 1214 between an origin location 1208 and a destination location 1212. The autonomous vehicle 124 may be commissioned by the sending user 128 to utilize the autonomous delivery location 104 as a waypoint 1210 in route to the destination location 1212. A network of autonomous robots 1204 may operate in concert to shuttle the payload 126 from the origin location 1208 to the destination location 1212 through the chain of nodes 1214 including the node serving as the waypoint 1210 being the autonomous delivery location 104.

In another embodiment, a method of a landing server 100 includes marking, using a processor and a memory, a geo-spatial location 102 in a radial vicinity 105 encompassing the geo-spatial location 102 as an autonomous delivery location 104 upon receiving a designation data 106 indicating the geo-spatial location 102 is the autonomous delivery location 104. The recipient user 110 indicates the geo-spatial location 102 as the autonomous delivery location 104 based on at least one of a current geospatial location of a mobile device 108 of the recipient user 110 and a map view marking 306 created by the recipient user 110 through a computing device 300. The autonomous delivery location 104 is associated with the recipient user 110 of the autonomous delivery network 150. It is determined determining that the recipient user 110 lives at a residence 116 associated with a claimable residential address 118 of the autonomous delivery network 150 formed through a social community algorithm of a privacy server, using a processor and a memory. The autonomous delivery location 104 is verified to be encompassed by a tract boundary 120 of the residence 116 prior to accepting the geo-spatial location 102 as the autonomous delivery location 104.

A navigation data 122 may be communicated, through a network 101, to an autonomous vehicle 124 to direct the autonomous vehicle 124 to the autonomous delivery location 104 of the recipient user 110 when a payload 126 associated with the autonomous vehicle 124 is requested by any one of the recipient user 110 and a sending user 128 to be physically delivered to the autonomous delivery location 104.

In yet another embodiment, an autonomous delivery network 150 includes a network 101 and at least one of a mobile device 108 and a computing device 300 associated with a recipient user 110 of an autonomous delivery network 150 to communicate a designation data 106 indicating a geo-spatial location 102 is an autonomous delivery location 104. The recipient user 110 indicates the geo-spatial location 102 as the autonomous delivery location 104 based on at least one of a current geospatial location of the mobile device 108 of the recipient user 110 and a map view marking 306 created by the recipient user 110 through the computing device 300. The autonomous delivery network 150 further includes a landing server 100, including a processor and a memory, communicatively coupled with at least one of the mobile device 108 and the computing device 300 through the network 101. The landing server 100 is configured to mark the geo-spatial location 102 as the autonomous delivery location 104 upon receipt of the designation data 106, associate the autonomous delivery location 104 with the recipient user 110 of the autonomous delivery network 150, and communicate a navigation data 122 to an autonomous vehicle 124 to direct the autonomous vehicle 124 to the autonomous delivery location 104 of the recipient user 110 when a payload 126 associated with the autonomous vehicle 124 is requested by any one of the recipient user 110 and a sending user 128 to be physically delivered to the autonomous delivery location 104.

A residence 116 algorithm may determine that the recipient user 110 lives at a residence 116 associated with a claimable residential address 118 of the autonomous delivery network 150 formed through a social community algorithm of a privacy server using a processor and a memory. A verification algorithm may verify the autonomous delivery location 104 is encompassed by a tract boundary 120 of the residence 116 and/or a public address 402 prior to accepting the geo-spatial location 102 as the autonomous delivery location 104. A public address 402 algorithm may determine that the recipient user 110 is associated with the public address 402 associated with a claimable public address 402 of the autonomous delivery network 150 formed through the social community algorithm of the privacy server using the processor and the memory. A recipient notification 600 algorithm may automatically notify the recipient user 110 at a time when the payload 126 is delivered to a residential address 118 and/or the public address 402. The public address 402 may be a work address, a park address, a public forum address, and/or a community center address. The recipient user 110 may indicate the geo-spatial location 102 as the autonomous delivery location 104 based on a current geospatial location of the mobile device 108 of the recipient user 110 and/or a map view marking 306 created by the recipient user 110 through the computing device 300.

A current location algorithm may determine the current geospatial location of the mobile device 108. An association algorithm may associate the current geospatial location of the mobile device 108 with the autonomous delivery location 104 in a radial vicinity 105 encompassing the current geospatial location of the mobile device 108 when the recipient user 110 of the mobile device 108 requests 304 the current geospatial location of their mobile device 108 as the autonomous delivery location 104. The autonomous delivery location 104 may be less than five meters in radial diameter from an epicenter 308 associated with the current geospatial location.

A location association algorithm may associate the autonomous delivery location 104 with the recipient user 110 of the autonomous delivery network 150. A navigation algorithm may direct the autonomous vehicle 124 to the autonomous delivery location 104 when a sending user 128 places the payload 126 in the autonomous vehicle 124 in route to the recipient user 110 through the autonomous delivery network 150. The sending user 128 may be a merchant 128C, a neighbor 128A, and/or a friend user 128B.

A share algorithm may permit the recipient user 110 to grant a friend user 128B of the recipient user 110 in the autonomous delivery network 150 permission to use the autonomous delivery location 104 of the recipient user 110. A friend notification 600 algorithm may notify the recipient user 110 and/or the friend user 128B when another payload 126 requested by the friend user 128B from the sending user 128 is delivered to the autonomous delivery location 104 based on a request 304 of the friend user 128B to deliver the another payload 126 to the autonomous delivery location 104. An occupied algorithm may automatically determine that the autonomous delivery location 104 is currently being occupied by another autonomous vehicle 124 and/or otherwise obstructed. A wait algorithm may send a message to the autonomous vehicle 124 to wait until the autonomous delivery location 104 is freed from obstruction. An obstruction algorithm may optionally notify the recipient user 110 when the autonomous delivery location 104 is obstructed.

An online algorithm may permit the recipient user 110 to select when the autonomous delivery location 104 is online. An offline algorithm may permit the recipient user 110 to select when the autonomous delivery location 104 is offline. A restriction algorithm may instruct the autonomous vehicle 124 to deliver the payload 126 only when the autonomous delivery location 104 is online. A ground safety algorithm may request 304 that the recipient user 110 verifies that the autonomous delivery location 104 is on a level ground 1110 and free from any land obstructions including a building 1102, a tree 1104, a blockage 1106, a fence 1108, and/or any land-based hazardous conditions. An aerial safety algorithm may request 304 that the recipient user 110 verifies that an associated airspace in which the autonomous vehicle 124 traverses above the autonomous delivery location 104 is free from any aerial obstructions including a power line, a utility pole 1114, a telephone line, a utility line, and/or any other aerial hazard condition.

A photo algorithm may automatically request 304 that the autonomous vehicle 124 take a photograph 604 to confirm a successful delivery 602 of the payload 126 at the autonomous delivery location 104. A confirmation algorithm may communicate the photograph 604 to the recipient user 110 when the successful delivery 602 of the payload 126 is made to provide proof of delivery. The mobile device 108 may be a mobile phone, a landing beacon device, and/or a landing pod. The autonomous vehicle 124 may be a rover vehicle, an autonomous robot, an autonomous bicycle, a quadcopter, an octocopter, a multirotor aircraft, and/or a fixed wing aircraft.

The autonomous delivery location 104 may be a node in a chain of nodes 1214 between an origin location 1208 and a destination location 1212. The autonomous vehicle 124 may be commissioned by the sending user 128 to utilize the autonomous delivery location 104 as a waypoint 1210 in route to the destination location 1212. A network of autonomous robots 1204 may operate in concert to shuttle the payload 126 from the origin location 1208 to the destination location 1212 through the chain of nodes 1214 including the node serving as the waypoint 1210 being the autonomous delivery location 104.

An example embodiment will now be described. In one embodiment, Bob may wish to have items delivered to his home. Bob may work several jobs and/or may not have time to run errands. As a result, Bob may be forced to spend much of his weekend going to the store and/or picking up items (e.g., goods). Bob may hear from a neighbor about the autonomous delivery network 150.

Bob may join the autonomous delivery network 150 (e.g., Fatdoor.com) and/or create a profile on the autonomous delivery network 150. Bob may claim and/or verify his residential address 118. Bob may walk out to his backyard and choose a spot to designate as his autonomous delivery location. There may be a corner of his yard where his kids to not play but is readily accessible. The corner may be on level ground and/or be free from obstructions. Bob may stand in the corner and indicate on his smart phone (e.g., by selecting a “Designate” button on his touch screen) that the current geo-spatial location 102 of his smart phone is the desired autonomous delivery location. Bob may be prompted to read terms of use and/or a disclaimer and/or accept terms and/or conditions (e.g., agreeing to assume responsibility of the autonomous delivery location and/or any damage caused in and/or around the autonomous delivery location). The geo-spatial location may be marked as Bob's autonomous delivery location.

Bob may be able to use the autonomous delivery network 150 to place orders from merchants 128C in his neighborhood and/or have payloads delivered to and/or from neighbors (e.g., borrow tools). The orders may be delivered right to his backyard and/or payments may be carried out through the autonomous delivery network. Bob may enjoy the ease of receiving deliveries in this manner, feel safe, and/or trust the autonomous delivery network 150 as he knows precisely when and/or where deliveries will be made. Bob may save money and/or precious time by joining the autonomous delivery network 150.

In another example embodiment, Jessica may own a small bakery. She may have a faithful clientele base in her neighborhood. However, Jessica may find that many of her faithful customers have stopped coming into the bakery as their schedules have become busy. Jessica may not have the financial means and/or resources to implement a delivery service. As a result, Jessica's bakery may suffer.

Jessica may see an autonomous vehicle operating in her neighborhood. She may learn about the autonomous delivery network 150 and/or join. Jessica may designate her work autonomous delivery location 104 using a map view marking 306 on her computer. As Jessica's bakery may be on a busy street, she may be thankful that she is able to select a precise location from where deliveries can be carried out. Jessica may designate her autonomous delivery location 104 in back of her store next to her parking spot. She may be able to change her autonomous delivery location 104 if her store expands and/or if she eventually buys a delivery van and/or want to park it in the autonomous delivery location.

Jessica may be able to advertise the autonomous delivery location to her friends and/or customers. Jessica may be able to make autonomous deliveries to her customers with peace of mind as she may not need to worry about failed deliveries and/or damage caused by the autonomous vehicle while making deliveries. Jessica may be able to save her bakery and/or expand her clientele. By using the autonomous delivery network 150, Jessica may be able to safely and/or affordably deliver goods to individuals in her neighborhood. She may even be able to lend a cup of sugar to her neighbor (provided her neighbor's autonomous delivery location is free from obstructions).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a landing server comprising:
marking, using a processor and a memory, a geo-spatial location in a radial vicinity encompassing the geo-spatial location as an autonomous delivery location upon receiving a designation data indicating the geo-spatial location is the autonomous delivery location,
wherein the designation data is communicated to the landing server through a network by a recipient user of an autonomous delivery network, and
wherein the recipient user indicates the geo-spatial location as the autonomous delivery location based on at least one of a current geospatial location of a mobile device of the recipient user and a map view marking created by the recipient user through a computing device;
associating the autonomous delivery location with the recipient user of the autonomous delivery network; and
communicating, through the network, a navigation data to an autonomous vehicle to direct the autonomous vehicle to the autonomous delivery location of the recipient user when a payload associated with the autonomous vehicle is requested by any one of the recipient user and a sending user to be physically delivered to the autonomous delivery location.

2. The method of claim 1 further comprising:
determining that the recipient user lives at a residence associated with a claimable residential address of the autonomous delivery network formed through a social community algorithm of a privacy server using a processor and a memory;
verifying the autonomous delivery location is encompassed by a tract boundary of the residence prior to accepting the geo-spatial location as the autonomous delivery location;
determining that the recipient user is associated with a public address associated with a claimable public address of the autonomous delivery network formed through the social community algorithm of the privacy server using the processor and the memory; and
verifying the autonomous delivery location is encompassed by the tract boundary of the public address prior to accepting the geo-spatial location as the autonomous delivery location,
wherein the autonomous delivery network to automatically notify the recipient user at a time when the payload is delivered to any one of a residential address and the public address, and
wherein the public address is at least one of a work address, a park address, a public forum address, and a community center address.

3. The method of claim 1 further comprising:
determining the current geospatial location of the mobile device;
associating the current geospatial location of the mobile device with the autonomous delivery location in the radial vicinity encompassing the current geospatial location of the mobile device when the recipient user of the mobile device requests the current geospatial location of their mobile device as the autonomous delivery location,
wherein the autonomous delivery location is not more than five meters in radial diameter from an epicenter associated with the current geospatial location;
associating the autonomous delivery location with the recipient user of the autonomous delivery network; and
directing the autonomous vehicle to the autonomous delivery location when the sending user places the payload in the autonomous vehicle in route to the recipient user through the autonomous delivery network,
wherein the sending user is at least one of a merchant, a neighbor, and a friend user.

4. The method of claim 1 further comprising:
permitting the recipient user to grant a friend user of the recipient user in the autonomous delivery network permission to use the autonomous delivery location of the recipient user;
notifying at least one of the recipient user and the friend user when another payload requested by the friend user from the sending user is delivered to the autonomous delivery location based on a request of the friend user to deliver the another payload to the autonomous delivery location;
automatically determining that the autonomous delivery location is at least one of currently being occupied by another autonomous vehicle and otherwise obstructed;
sending a message to the autonomous vehicle to wait until the autonomous delivery location is freed from obstruction; and
optionally notifying the recipient user when the autonomous delivery location is obstructed.

5. The method of claim 4 further comprising:
permitting the recipient user to select when the autonomous delivery location is online;
permitting the recipient user to select when the autonomous delivery location is offline;
instructing the autonomous vehicle to deliver the payload only when the autonomous delivery location is online;
requesting that the recipient user verifies that the autonomous delivery location is on a level ground and free from any land obstructions comprising any one of a building, a tree, a blockage, a fence, and any land-based hazardous conditions; and
requesting that the recipient user verifies that an associated airspace in which the autonomous vehicle traverses above the autonomous delivery location is free from any aerial obstructions comprising a power line, a utility pole, a telephone line, a utility line, and any other aerial hazard condition.

6. The method of claim 5 further comprising:
automatically requesting that the autonomous vehicle take a photograph to confirm a successful delivery of the payload at the autonomous delivery location; and
communicating the photograph to the recipient user when the successful delivery of the payload is made to provide proof of delivery,
wherein the mobile device is at least one of a mobile phone, a landing beacon device, and a landing pod, and
wherein the autonomous vehicle is at least one of a rover vehicle, an autonomous robot, an autonomous bicycle, a quadcopter, an octocopter, a multirotor aircraft, and a fixed wing aircraft.

7. The method of claim 1 further comprising at least one:
wherein the autonomous delivery location is a node in a chain of nodes between an origin location and a destination location,
wherein the autonomous vehicle commissioned by the sending user to utilize the autonomous delivery location as a waypoint in route to the destination location,
wherein a network of autonomous robots operate in concert to shuttle the payload from the origin location to the destination location through the chain of nodes including the node serving as the waypoint being the autonomous delivery location, and
wherein the autonomous delivery location is associated with a private neighborhood social network in which each user is verified based on an address data and in which each user is able to designate certain information as being private.

8. A method of a landing server comprising:
marking, using a processor and a memory, a geo-spatial location in a radial vicinity encompassing the geo-spatial location as an autonomous delivery location upon receiving a designation data indicating the geo-spatial location is the autonomous delivery location,
wherein the recipient user indicates the geo-spatial location as the autonomous delivery location based on at least one of a current geospatial location of a mobile device of the recipient user and a map view marking created by the recipient user through a computing device;
associating the autonomous delivery location with the recipient user of the autonomous delivery network;
determining that the recipient user lives at a residence associated with a claimable residential address of the autonomous delivery network formed through a social community algorithm of a privacy server, using a processor and a memory; and
verifying the autonomous delivery location is encompassed by a tract boundary of the residence prior to accepting the geo-spatial location as the autonomous delivery location.

9. The method of claim 8 further comprising:
communicating, through a network, a navigation data to an autonomous vehicle to direct the autonomous vehicle to the autonomous delivery location of the recipient user when a payload associated with the autonomous vehicle is requested by any one of the recipient user and a sending user to be physically delivered to the autonomous delivery location;
determining that the recipient user is associated with a public address associated with a claimable public address of the autonomous delivery network formed through the social community algorithm of the privacy server using the processor and the memory; and
verifying the autonomous delivery location is encompassed by the tract boundary of the public address prior to accepting the geo-spatial location as the autonomous delivery location,
wherein the autonomous delivery network to automatically notify the recipient user at a time when a payload is delivered to any one of a residential address and the public address, and
wherein the public address is at least one of a work address, a park address, a public forum address, and a community center address.

10. The method of claim 8 further comprising:
determining the current geospatial location of the mobile device;
associating the current geospatial location of the mobile device with the autonomous delivery location in the radial vicinity encompassing the current geospatial location of the mobile device when the recipient user of the mobile device requests the current geospatial location of their mobile device as the autonomous delivery location,
wherein the autonomous delivery location is less than five meters in radial diameter from an epicenter associated with the current geospatial location;
associating the autonomous delivery location with the recipient user of the autonomous delivery network; and
directing the autonomous vehicle to the autonomous delivery location when a sending user places a payload in the autonomous vehicle in route to the recipient user through the autonomous delivery network,
wherein the sending user is at least one of a merchant, a neighbor, and a friend user.

11. The method of claim 8 further comprising:
permitting the recipient user to grant a friend user of the recipient user in the autonomous delivery network permission to use the autonomous delivery location of the recipient user;
notifying at least one of the recipient user and the friend user when another payload requested by the friend user from the sending user is delivered to the autonomous delivery location based on a request of the friend user to deliver the another payload to the autonomous delivery location;
automatically determining that the autonomous delivery location is at least one of currently being occupied by another autonomous vehicle and otherwise obstructed;
sending a message to the autonomous vehicle to wait until the autonomous delivery location is freed from obstruction; and
optionally notifying the recipient user when the autonomous delivery location is obstructed.

12. The method of claim 11 further comprising:
permitting the recipient user to select when the autonomous delivery location is online;
permitting the recipient user to select when the autonomous delivery location is offline;
instructing the autonomous vehicle to deliver a payload only when the autonomous delivery location is online;
requesting that the recipient user verifies that the autonomous delivery location is on a level ground and free from any land obstructions comprising any one of a building, a tree, a blockage, a fence, and any land-based hazardous conditions; and
requesting that the recipient user verifies that an associated airspace in which the autonomous vehicle traverses above the autonomous delivery location is free from any aerial obstructions comprising a power line, a utility pole, a telephone line, a utility line, and any other aerial hazard condition.

13. The method of claim 12 further comprising:
automatically requesting that the autonomous vehicle take a photograph to confirm a successful delivery of the payload at the autonomous delivery location; and
communicating the photograph to the recipient user when the successful delivery of the payload is made to provide proof of delivery,
wherein the mobile device is at least one of a mobile phone, a landing beacon device, and a landing pod, and
wherein the autonomous vehicle is at least one of a rover vehicle, an autonomous robot, an autonomous bicycle, a quadcopter, an octocopter, a multirotor aircraft, and a fixed wing aircraft.

14. The method of claim 8 further comprising:
wherein the autonomous delivery location is a node in a chain of nodes between an origin location and a destination location,
wherein the autonomous vehicle commissioned by the sending user to utilize the autonomous delivery location as a waypoint in route to the destination location, and
wherein a network of autonomous robots operate in concert to shuttle a payload from the origin location to the destination location through the chain of nodes including the node serving as the waypoint being the autonomous delivery location.

15. An autonomous delivery network comprising:
a network;
at least one of a mobile device and a computing device associated with a recipient user of an autonomous delivery network to communicate a designation data indicating a geo-spatial location is an autonomous delivery location,
wherein the recipient user indicates the geo-spatial location as the autonomous delivery location based on at least one of a current geospatial location of the mobile device of the recipient user and a map view marking created by the recipient user through the computing device; and
a landing server, including a processor and a memory, communicatively coupled with the at least one of the mobile device and the computing device through the network to:
mark the geo-spatial location as the autonomous delivery location upon receipt of the designation data,
associate the autonomous delivery location with the recipient user of the autonomous delivery network, and
communicate a navigation data to an autonomous vehicle to direct the autonomous vehicle to the autonomous delivery location of the recipient user when a payload associated with the autonomous vehicle is requested by any one of the recipient user and a sending user to be physically delivered to the autonomous delivery location.

16. The autonomous delivery network of claim 15 further comprising:
a residence algorithm to determine that the recipient user lives at a residence associated with a claimable residential address of the autonomous delivery network formed through a social community algorithm of a privacy server using a processor and a memory;
a verification algorithm to verify the autonomous delivery location is encompassed by a tract boundary of at least one of the residence and a public address prior to accepting the geo-spatial location as the autonomous delivery location;
a public address algorithm to determine that the recipient user is associated with the public address associated with a claimable public address of the autonomous delivery network formed through the social community algorithm of the privacy server using the processor and the memory; and
a recipient notification algorithm to automatically notify the recipient user at a time when the payload is delivered to any one of a residential address and the public address,
wherein the public address is at least one of a work address, a park address, a public forum address, and a community center address, and
wherein the recipient user indicates the geo-spatial location as the autonomous delivery location based on at least one of a current geospatial location of the mobile device of the recipient user and a map view marking created by the recipient user through the computing device.

17. The autonomous delivery network of claim 16 further comprising:
a current location algorithm to determine the current geospatial location of the mobile device; and
an association algorithm to associate the current geospatial location of the mobile device with the autonomous delivery location in a radial vicinity encompassing the current geospatial location of the mobile device when the recipient user of the mobile device requests the current geospatial location of their mobile device as the autonomous delivery location,
wherein the autonomous delivery location is less than five meters in radial diameter from an epicenter associated with the current geospatial location.

18. The autonomous delivery network of claim 17 further comprising:
a location association algorithm to associate the autonomous delivery location with the recipient user of the autonomous delivery network; and
a navigation algorithm to direct the autonomous vehicle to the autonomous delivery location when a sending user places the payload in the autonomous vehicle in route to the recipient user through the autonomous delivery network,
wherein the sending user is at least one of a merchant, a neighbor, and a friend user.

19. The autonomous delivery network of claim 15 further comprising:
a share algorithm to permit the recipient user to grant a friend user of the recipient user in the autonomous delivery network permission to use the autonomous delivery location of the recipient user;
a friend notification algorithm to notify at least one of the recipient user and the friend user when another payload requested by the friend user from the sending user is delivered to the autonomous delivery location based on a request of the friend user to deliver the another payload to the autonomous delivery location;
an occupied algorithm to automatically determining that the autonomous delivery location is at least one of currently being occupied by another autonomous vehicle and otherwise obstructed;
a wait algorithm to send a message to the autonomous vehicle to wait until the autonomous delivery location is freed from obstruction;
an obstruction algorithm to optionally notify the recipient user when the autonomous delivery location is obstructed;
an online algorithm to permit the recipient user to select when the autonomous delivery location is online;
an offline algorithm to permit the recipient user to select when the autonomous delivery location is offline;
a restriction algorithm to instruct the autonomous vehicle to deliver the payload only when the autonomous delivery location is online;
a ground safety algorithm to request that the recipient user verifies that the autonomous delivery location is on a level ground and free from any land obstructions comprising any one of a building, a tree, a blockage, a fence, and any land-based hazardous conditions;
an aerial safety algorithm to request that the recipient user verifies that an associated airspace in which the autonomous vehicle traverses above the autonomous delivery location is free from any aerial obstructions comprising a power line, a utility pole, a telephone line, a utility line, and any other aerial hazard condition;
a photo algorithm to automatically request that the autonomous vehicle take a photograph to confirm a successful delivery of the payload at the autonomous delivery location; and
a confirmation algorithm to communicate the photograph to the recipient user when the successful delivery of the payload is made to provide proof of delivery,
wherein the mobile device is at least one of a mobile phone, a landing beacon device, and a landing pod, and
wherein the autonomous vehicle is at least one of a rover vehicle, an autonomous robot, an autonomous bicycle, a quadcopter, an octocopter, a multirotor aircraft, and a fixed wing aircraft.

20. The autonomous delivery network of claim 15:
wherein the autonomous delivery location is a node in a chain of nodes between an origin location and a destination location,
wherein the autonomous vehicle commissioned by the sending user to utilize the autonomous delivery location as a waypoint in route to the destination location, and
wherein a network of autonomous robots operate in concert to shuttle the payload from the origin location to the destination location through the chain of nodes including the node serving as the waypoint being the autonomous delivery location.
